(19) United States
(12) Patent Application Publication
(10) Pub. No.: US 2014/0258093 A1
(43) Pub. Date: Sep. 11, 2014

(54) METHODS AND SYSTEMS FOR SELF-FUNDING INVESTMENTS

(71) Applicant: Clearmatch Holdings (Singapore) Pte. Ltd., Singapore (SG)

(72) Inventors: Philip Gardiner, Melbourne (AU); Matthew John Symons, Sydney (AU); Greg Symons, Sydney (AU)

(73) Assignee: CLEARMATCH HOLDINGS (SINGAPORE) PTE. LTD., Singapore (SG)

(21) Appl. No.: 14/198,222

(22) Filed: Mar. 5, 2014

Related U.S. Application Data
(60) Provisional application No. 61/773,641, filed on Mar. 6, 2013.

(51) Int. Cl. G06Q 40/02

(52) U.S. Cl. CPC G06Q 40/025; G06Q 40/06
USPC 705/38

(57) ABSTRACT

Methods, systems and/or computer instructions of enabling the creation and configuration of lending circles for members of organized communities, while optionally maintaining the anonymity of members.

### RELATED APPLICATIONS

This application claims the benefit of and priority to U.S. provisional application Serial number No. 61/773,641, filed Mar. 6, 2013, the contents of which are hereby incorporated by reference as if recited in full herein for all purposes.

### BACKGROUND

The inventive subject matter disclosed herein relates to lending marketplace for loans. A lending marketplace includes borrowers seeking loans and investors who agree to provide the loan funds in return for a commitment from the borrower to repay the funds on agreed terms. Traditionally, loans for consumers have been offered/funded by a bank as the investor, but increasingly marketplaces are evolving that provide greater access for a wider range of participants to act as investors.

The pricing of loans is a function of traditional supply and demand, but with the added dimension of risk profiles. Demand represents the number of borrowers of a particular risk profile, and the supply represents the amount of investment funding available for borrowers of that risk profile. An added nuance is that on the supply side, risk is ultimately perceived rather than actual, with investor perceptions based on any number of factors—most commonly including the borrower's credit risk score, but possibly including other factors such as socioeconomic factors (location, job category, education, etc.) and behavioral factors (job tenure, time to complete tertiary education, job promotion rate, etc.)

As a general rule, large financial institutions control loan funding, pricing and lending practices and policies. This is a disadvantage not only for borrowers but also for private individuals or groups who would like to participate as investors in the lending market.

For example, within communities of professional practices (e.g., radiographers, dentists, veterinarians, accountants, etc.) members are often both borrowers and investors. Some members, such as new members starting out, are more likely to be net borrowers. Other members, such as members with established businesses, may be net investors or even investors only. In some situations or territories, all members may be investors by virtue of a requirement to make contributions. For instance, members may be required to contribute to pension or superannuation funds, which is a form of a pension fund mandated in Australia. Hence, the community as a whole might be seen to be self-funding, either fully or at least partially. Peer-to-peer lending (also known as person-to-person lending, peer-to-peer investing, and social lending; abbreviated frequently as “P2P” lending) is the practice of lending money to unrelated individuals, or “peers”, without going through a traditional financial intermediary such as a bank or other traditional financial institution.

The traditional approach for members of such communities, as it is for the wider public, is to source lending and investment products through large lending institutions, such as banks, superfunds, etc.

The problem for these investors especially in categories such as the ‘fixed income’ asset class is that the range of investment options is limited and the ability to invest in debt products specific to borrowers within their own or related industries is virtually nonexistent. These investors tend to default to investing in a fixed income portfolio made up of more traditional fixed income products such as term deposits and government or corporate bonds that may offer only relatively low rates of return.

The problem for some borrowers, especially those with strong credit profiles and advanced qualifications is that they often find themselves paying interest rates on their personal or small business borrowing that do not reflect their low probability of loan default. This reflects the widespread phenomena that risk-adjusted pricing is not widely available in many of the large institution dominated credit markets where a one-size-fits-all credit model still tends to dominate risk assessment and therefore credit pricing.

As a consequence of the foregoing issues and practices, members of these communities of practice and professional associations do not have either a) the opportunity to invest in higher yielding fixed income type debt products targeted specifically at members of their own association b) benefit from the lower rates that might be possible if lenders from within these communities of practice or professional associations were able to arrange debt funding directly from other members.

One consequence of this is that these communities of practice or professional associations forfeit large margins to traditional institutional lenders—i.e., the difference between the rates they pay on loans versus the returns they receive on investments. For example, suppose an established Radiographer pays 13% on a secured loan for imaging equipment, yet receives a return on the cash component of their self-managed superannuation fund of only 3%. In this example the bank is able to capture a 1000 basis point spread between the cost of funding (the deposit rate) and the rate charged for the equipment finance loan.

A further complication for members of communities of practice or professional associations is that is that returns from their traditional fixed income investment portfolios (typically made up of Term Deposits, Cash Deposits or bonds) tend to decline in falling global interest rate environments yet financial institutions do not necessarily pass on to members of these communities or practice or professional associations the benefit of these declining interest rates in the form of cheaper borrowing costs, Hence there exists an opportunity for communities or practice or professional associations to self-fund (partially or completely) their own financing needs whilst at the same time providing individual members of that association with a) a new and high yielding fixed income asset class b) an asset class in which they are well placed to assess borrower default risk as they are practitioners within the industry into which the loans are being written.

Finally investors who are not part of the community or practice or the professional association may find it attractive to invest in loans written to members of that community. This may be especially true in situations where for instance in the radiographer example outlined above members of the professional association provide 50% of the funding required to purchase radiography equipment and the balance of the required funding is provided by investors who are essentially ‘co-investing’ alongside radiographers to fund equipment purchases required to operate their businesses.

In summary, existing lending approaches do not adequately address the following needs, as well as others not specifically mentioned:

### Customer Needs:

A member-based funding mechanism offering members of communities of practice or professional associations (hereinafter “Members” or “members”) a better deal:
   Members who are borrowers have few choices but to borrow from large financial institutions who are able to capture large spreads by charging even low risk borrowers ‘standard small business lending rates’
   Members who are investors are seeing fixed income returns decline in their current portfolio and are looking for fixed income asset classes that offer a) better returns b) risks they can understand and are familiar with
   Investors who are not Members are seeking fixed income investment returns that are both reasonable and not correlated to the market
Members must have confidence they are investing in Members but not breach privacy or credit laws by revealing the actual identity of members. Such a solution must be able to:
   Provide members contemplating investments with the following
      Accurate and useful profiles of loan applicants (but not personally identifiable information about the loan applicant)
      Validation of the loan purpose
      Details of other investors that have funded the loan
      Compliance with investment regulations
   Provide Members seeking loans with the following:
      Ensuring that their loan application is listed and visible to potential investors
      Preserving control over which categories of investor will have visibility of the loan application and or the sequence with which different investor categories will be exposed to the loan
      Opportunities to distinguish/highlight the credit worthiness of their loan application
      Preserve their anonymity

### SUMMARY

At a high level, the inventive subject matter addresses the aforementioned problems and needs by providing at least the following high-level solutions:
A way of enabling communities to form virtual lending circles where Members can capture the margin spread on their business
A way of managing the identities of Members to ensure an appropriate balance between preservation of anonymity versus providing sufficient information to support investor decision-making
A range of models that suit different scenarios, such as closed loops, partially closed loops, self-exclusion loops, etc.

These and other advantages of the inventive subject matter are discussed in more detail below.

### BRIEF DESCRIPTION OF THE DRAWINGS

The Figures accompanying this specification show representative embodiments according to various lines of inventive subject matter.

FIG. 1 is a diagram of an example customer record for a P2P lending marketplace computer system.

FIG. 2 is block diagram of an example scheme for establishing an Originator in a P2P lending marketplace computer system.

FIG. 3 is a flowchart of an example scheme for creating a validated lending circle in a P2P lending marketplace computer system.

FIG. 4 is a diagram of an example closed-loop lending circle in a P2P lending marketplace computer system.

FIG. 5 is a diagram of an example of a possible lending scheme in a closed lending circle in a P2P lending marketplace computer system.

FIG. 6 is a diagram of an example of another possible lending scheme for a closed lending circle in a P2P lending marketplace computer system.

FIG. 7 is a diagram of an example of yet another possible lending scheme for a lending circle in a P2P lending marketplace computer system.

FIG. 8 is a diagram of an example scheme for allocation or dissemination of loan listings or offerings in a P2P lending marketplace computer system.

FIG. 9 is a flowchart of an example lending scheme for borrower-nominated investors in a P2P lending marketplace computer system.

FIG. 10 is an example user interface for user inputs, settings, or preferences in a P2P lending marketplace computer system.

FIG. 11 is another example user interface for user inputs, settings, or preferences in a P2P lending marketplace computer system.

FIG. 12 is a diagram of an example another scheme for allocation or dissemination of loan listings or offerings in a P2P lending marketplace computer system.

FIG. 13 is a diagram of an example yet another scheme for allocation or dissemination of loan listings or offerings in a P2P lending marketplace computer system.

FIG. 14 is another example user interface for user inputs, settings, or preferences in a P2P lending marketplace computer system.

FIG. 15 is a diagram of another scheme for allocation or dissemination of loan listings or offerings in a P2P lending marketplace computer system.

FIG. 16 is a diagram of another example scheme for creating a lending circle in a P2P lending marketplace computer system.

FIG. 17 is a diagram of an example scheme for managing investments in a P2P lending marketplace computer system.

FIG. 18 is a block diagram of a peer-to-peer lending system.

FIG. 19 is a block diagram illustrating components associated with a peer-to-peer lending system.

FIG. 20 is a flowchart illustrating a method a registering an investor.

FIG. 21 is a flowchart illustrating a method of registering a borrower.

FIG. 22 is a flowchart illustrating a method of authenticating an applicant's banking and social networking accounts with their customer profile during the registration process.

FIG. 23 is a flowchart illustrating a method of a borrower requesting a loan.

FIG. 24 is a flowchart illustrating the creation of a loan qualification score for a borrower.

FIG. 25 is a flowchart illustrating a method of a borrower's loan qualification score being updated.

FIG. 26 is a flowchart illustrating a method of an investor setting up a customer loan scorecard on a peer-to-peer lending system.

FIG. 27 is a flowchart illustrating a method a borrower setting the maximum loan pricing they are prepared to accept.

FIG. 28 is a flowchart illustrating a method of posting a borrower's loan application on the system for funding.

FIG. 29 is a flowchart illustrating a method of investors setting automatic funding instructions.

FIG. 30 is a screen shot or graphical user interface depicting a borrower's option to request a loan with dynamic pricing.

FIG. 31 is a description of the process of developing behavior based competency scores that are predictive of creditworthiness.

FIG. 32 is an exemplary diagram of a computing environment in which systems and methods consistent with the principles of the invention may be implemented.

### DETAILED DESCRIPTION

The inventive subject matter is generally directed to various systems, methods and software applications for enabling lending in lending circles formed of a community of members, which may be referred to herein as a peer-to-peer (P2P) lending marketplace. Applicant's prior pending application U.S. Ser. No. 14/011,313 may have relevant background on P2P lending schemes or profiling and qualifying of borrowers and other participants in a lending scheme, and the disclosure of that application is hereby incorporated by reference in its entirety for all purposes.

In connection with some or all of the scenarios presented below, the inventive subject matter, in some embodiments, is directed to the creation of customer identity profiles on the system that provide anonymity, i.e., no personal information that directly identifies a customer, while also providing trust in the integrity of the system, enable borrowing members to promote themselves and their creditworthiness, and provide investing members with accurate, validated representations of borrowers and their reasons for seeking loans.

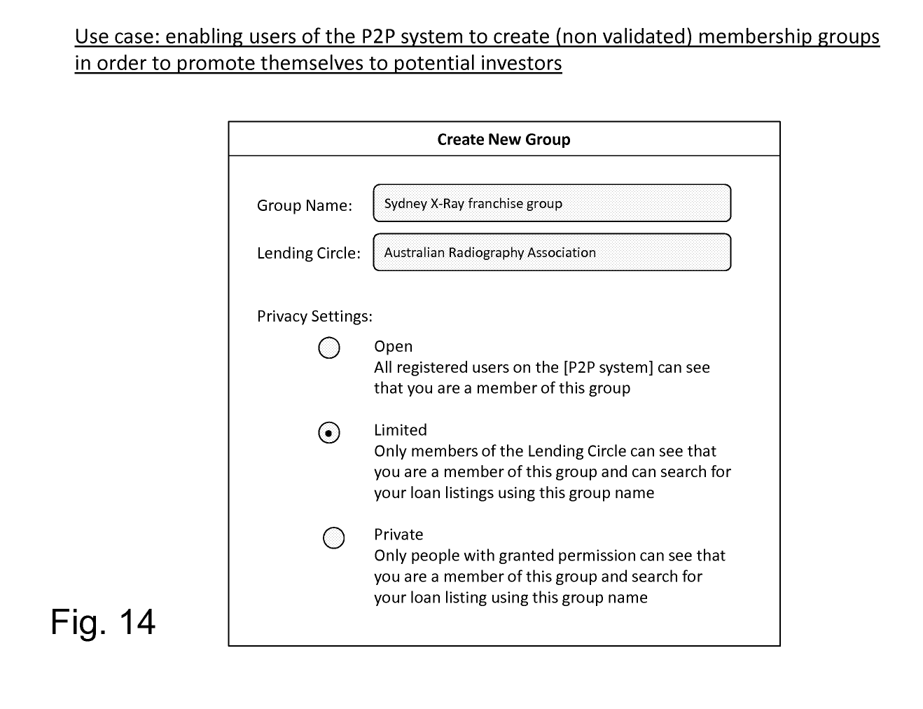

In connection with some or all of the scenarios presented below, the inventive subject matter, in some embodiments, is directed to enabling members of a lending group to form a subgroup (such as a franchise group within a Radiography Association) to promote themselves to potential investors. FIG. 14 illustrates a representative graphical user interface that would allow a registered user to create their lending circle, whereby that lending circle is, for example, a subgroup (e.g., group of franchise Radiographers) of a higher level lending circle (e.g., Australian Radiographers Association). This group may or may not be validated depending on whether there are validation rules attached to the lending circle or its creation.

The creation of a subgroup enables the members to promote themselves either within a larger lending circle (i.e., ‘Limited’ privacy) or among all users of the P2P system (i.e., ‘Open’ privacy).

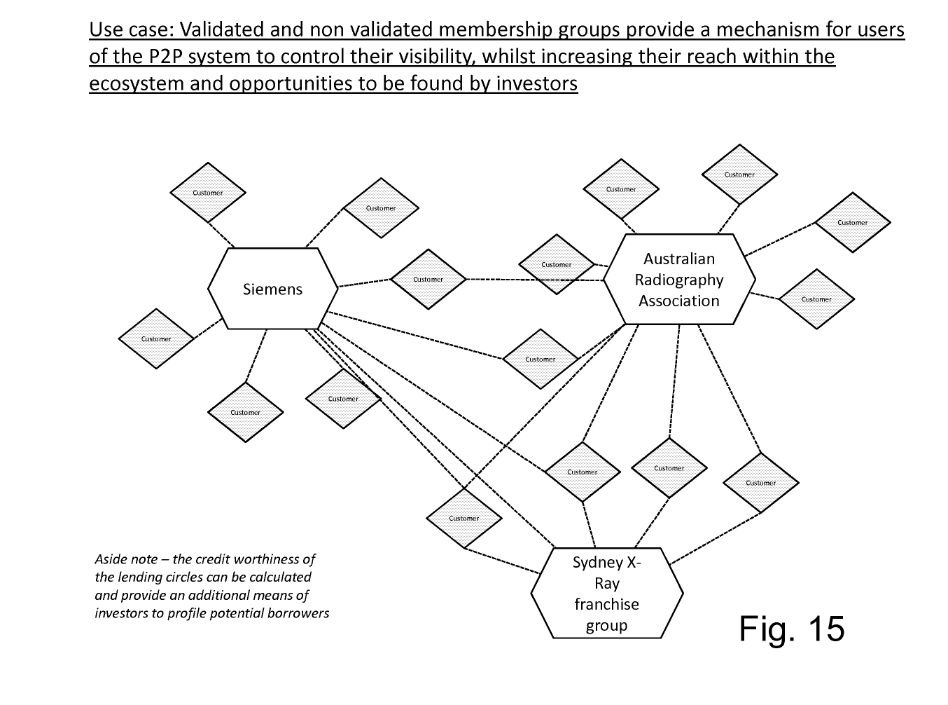

FIG. 15 represents the creation of network associations between registered users of the P2P system that enable them to increase their reach within the ecosystem and hence opportunities to find investors, or conversely identity other users to invest in.

In connection with some or all of the scenarios presented below, the inventive subject matter, in some embodiments, is directed to a mechanism for a third party to enable funding of goods or services from the third party. For example, a manufacturer may seek to create a mechanism for their customers to obtain finance to purchase their equipment, e.g., selling photocopiers to offices; selling imaging equipment to Radiography Association members, etc.

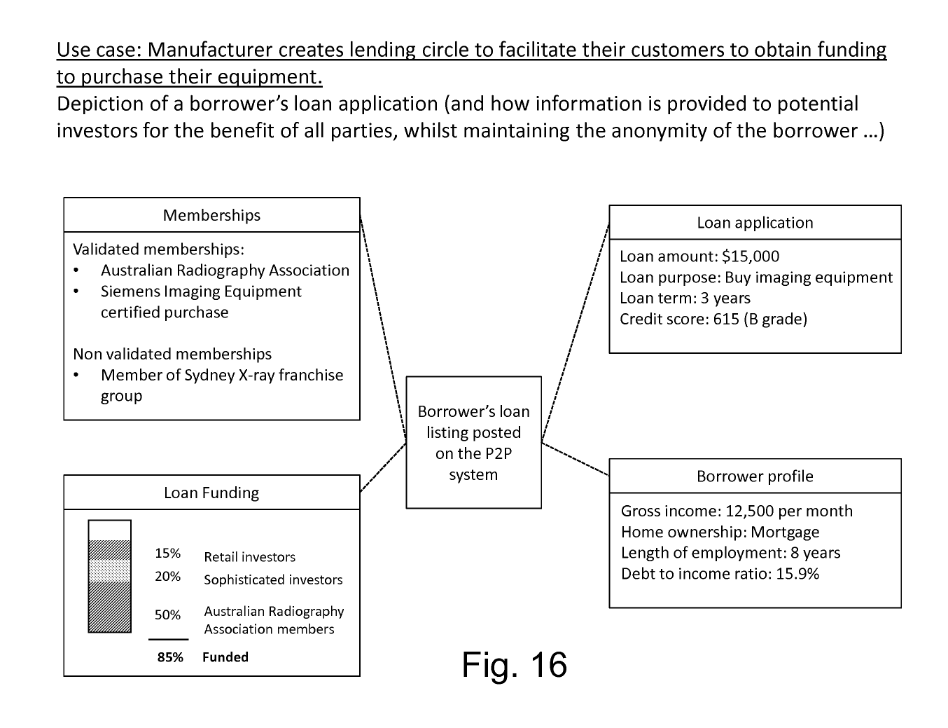

In connection with the foregoing embodiment and others disclosed herein, FIG. 16 illustrates how the P2P system retains anonymity of members, while providing useful information to principal investors. In this example the ‘loan application’ and ‘borrower profile’ is typical of the information provided to investors in existing P2P systems.

Beyond traditional information, the inventive subject matter contemplates providing lenders with additional profile information about the loan applicants' memberships and the level of loan funding. Such information enables lenders with significant additional insights for making funding decisions. In this case example, the additional information might include, for instance:
That the loan application is a member of the Radiography Association
They are also a member of a franchise group (i.e., further identifies the member)
That the loan application is for the purchase of imaging equipment
That the loan is being funded largely by other peer members of the loan applicant (i.e., Radiographers Association)

In connection with some or all of the scenarios presented below, the inventive subject matter, in some embodiments, is directed to a system that can measure the creditworthiness of members and performance of lending circles, and in doing so provide investors with additional insights. The idea that the creditworthiness of the lending circle can be calculated and provide additional information to potential investors provides a means of the lending circle of promoting themselves, plus a means of supporting members of the lending circle with little history.

Scenario Examples of Lending Circles that are: Closed Loop Versus Partially Closed Loops, with and without Origination Parties, and with and without Subordinated Levels of Investors

Scenario 1: Closed Loop Lending Circles, with an Originator

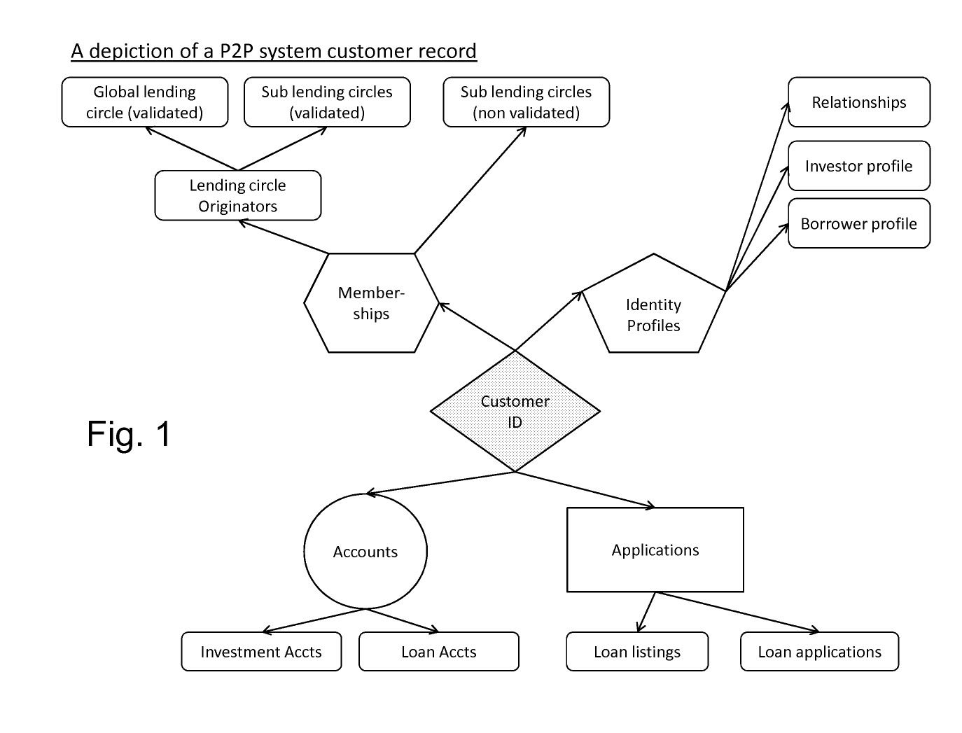

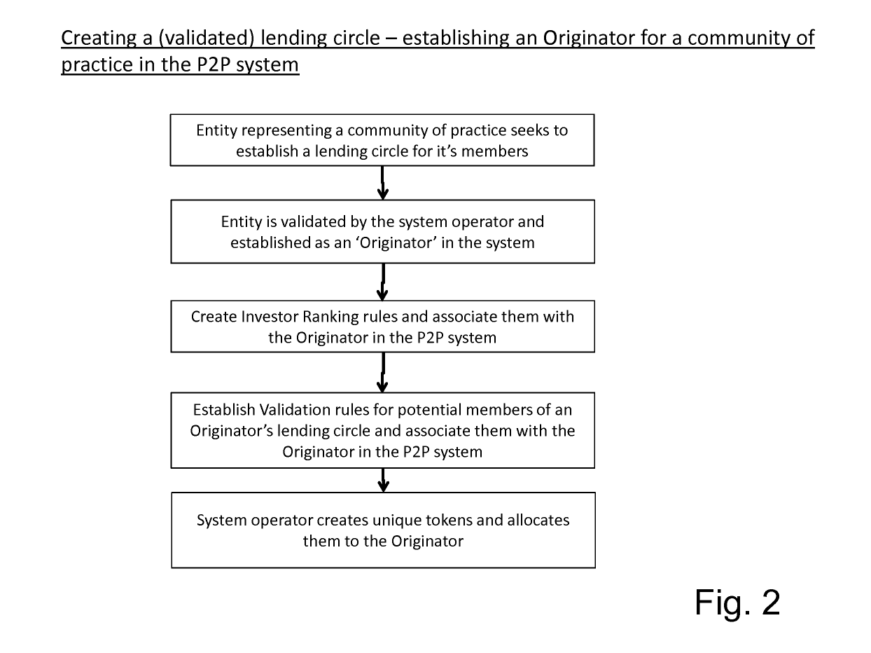

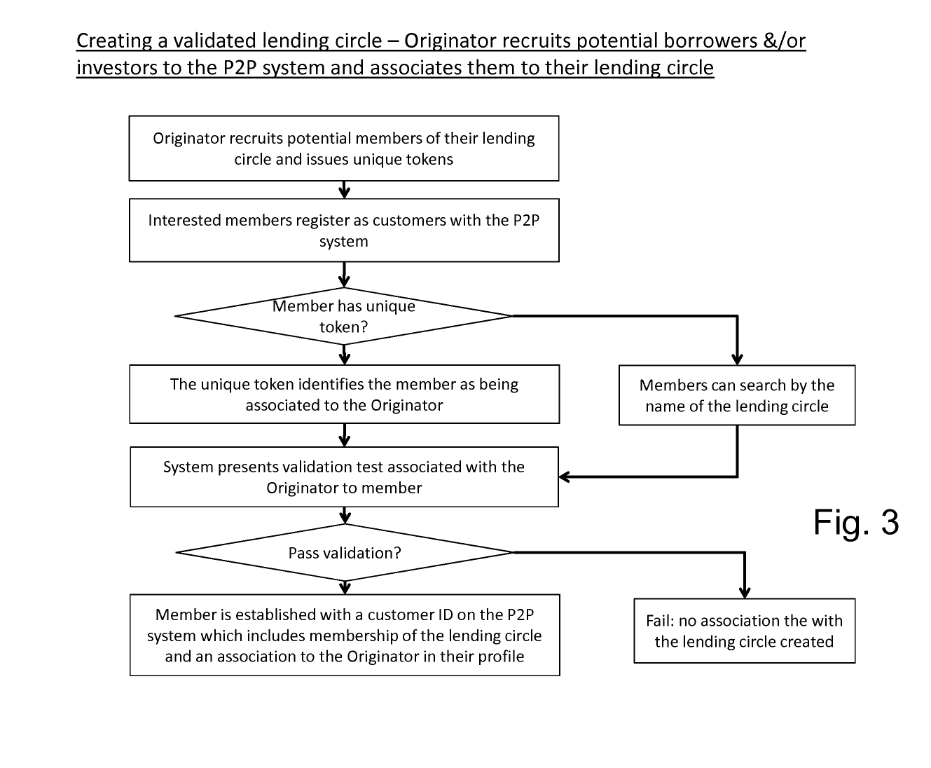

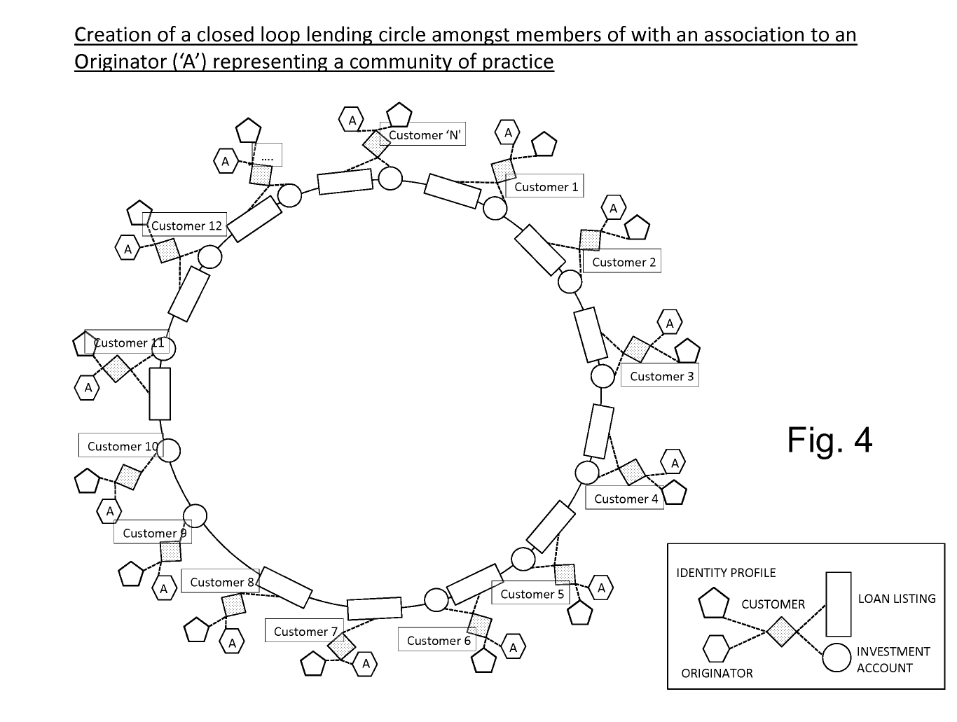

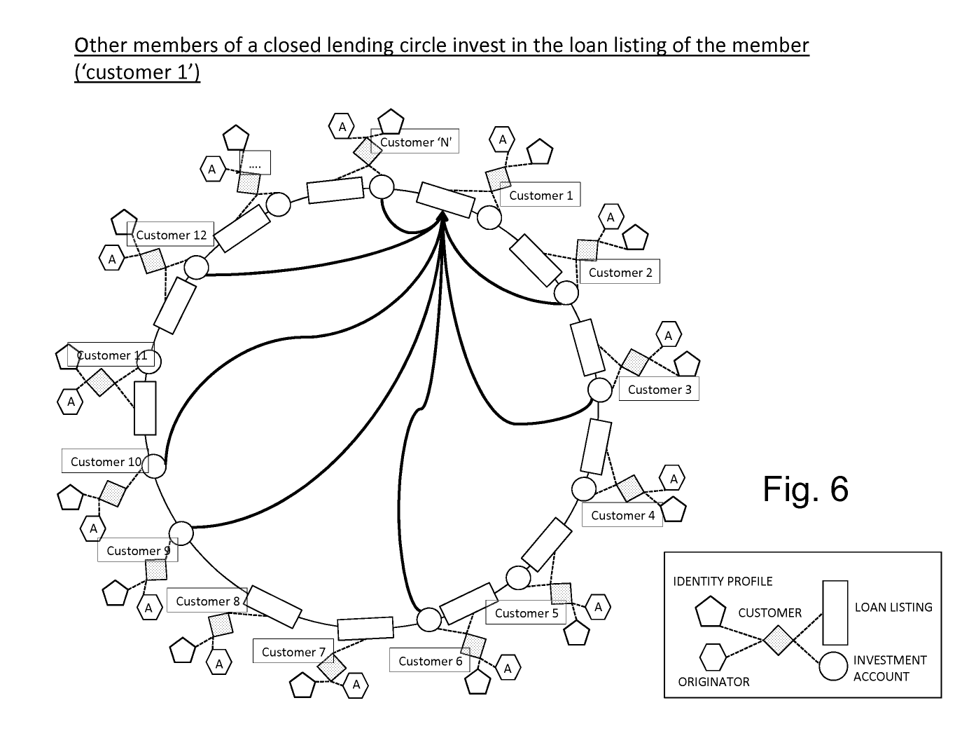

Under this scenario, an association creates a self-funding lending circle among its members to enable them (in aggregate) to capture a much greater proportion of the margin spreads (than currently occurs with banks and finance companies). In creating the self-funding lending circle, the association acts an Originator that establishes the validation rules that members must pass to join, establishes bidding rules for investors, and assists in attracting members. Members who join that lending circle are associated with each other via common associations with the Originator. In connection with this scenario, FIG. 1 depicts an example customer record in the system (being effectively the atomic level). Also in connection with this scenario, FIGS. 2-3 illustrates how, for example, Originators are established in the system. They may recruit members to register with the P2P system. Each registering member obtains a customer record, which includes an association to the Originator. FIGS. 4-6 illustrate how, for example, lending circles are established within the system, and how each member can both create their own loan listings and invest in the loan listings of other members. For instance, a lending circle made entirely up of members of an association, such as Australian Radiography Association. The assumption here is that the lending circle is able to self-fund the lending requirements of its members.

The originator is responsible for:
Determining the eligibility criteria of members
Setting the bidding rules that determine bidding priority
Assisting to recruit members
   Scenario 2: Partially Closed Loop Lending Circles, with an Originator

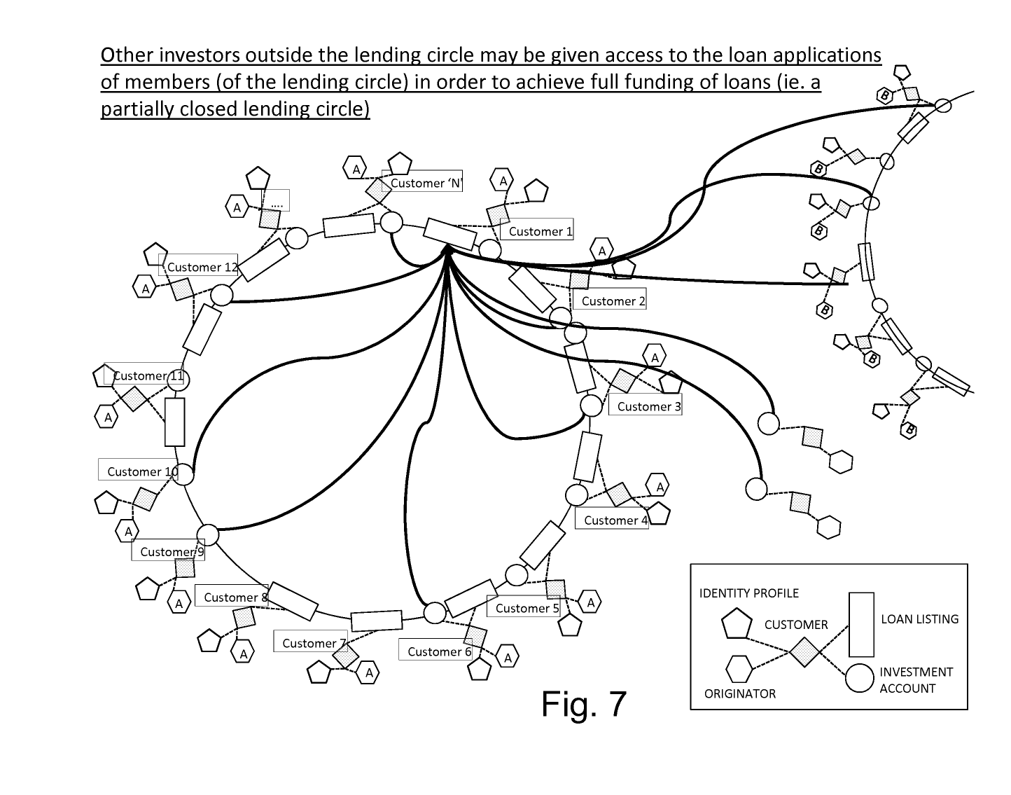

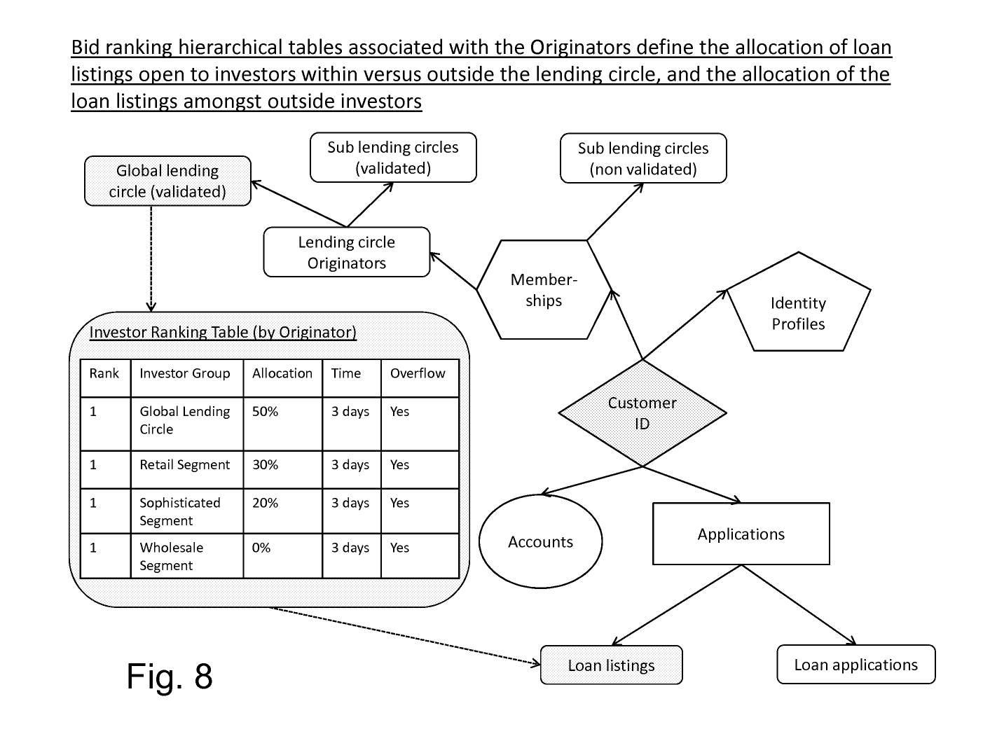

An association creates a lending circle among its members and provides them with priority access to fund loan applications, but it also allows other investors (outside their lending circle) access to achieve full funding of loans. In connection with this scenario, FIG. 7 illustrates how, for example, investors from outside the lending circle can fund loan listings. Also in connection with this scenario, FIG. 8A depicts an example Investor Ranking table associated to an Originator that controls whether funding of a particular loan listing by investors outside the lending circle is allowed, and if so how much, and under what rules. For example, a lending circle, as per Scenario 1, that also allows some investment in loan listings from investors outside the lending circle. The members of the lending circle will have priority access to invest in the loan listings of its members.

The originator is responsible for:
As per scenario 1, plus setting the allocation of investment allowable by community members versus external investors
   Scenario 3: Self-Excluded (Closed or Partially Closed) Lending Circles, with an Originator

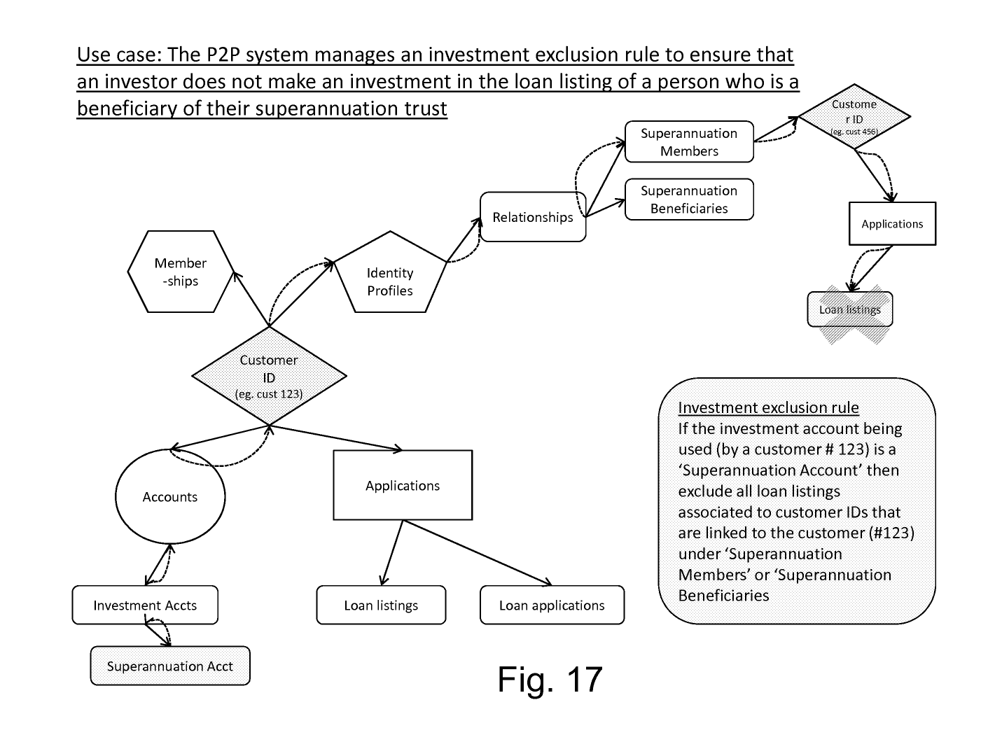

A member of a lending circle, who is both a borrower and an investor, seeks to ensure that their investment portfolio excludes any loans to themselves, other members of their personal superannuation trust, or their children (in order to comply with, self-funding restrictions, such as Australian regulations set out for self-managed superannuation funds). In connection with this scenario, FIG. 17 depicts, for example, how the system uses a combination of exclusion rules and relationships associated with a customer ID to manage the task. For example, a member of an association requests to be excluded from investing in their own loans (e.g., to comply with self-managed superannuation rules).

The originators responsibilities are as per Scenarios 1 & 2.

Scenario 4: Closed Loop Lending Circles, without an (Explicit) Originator

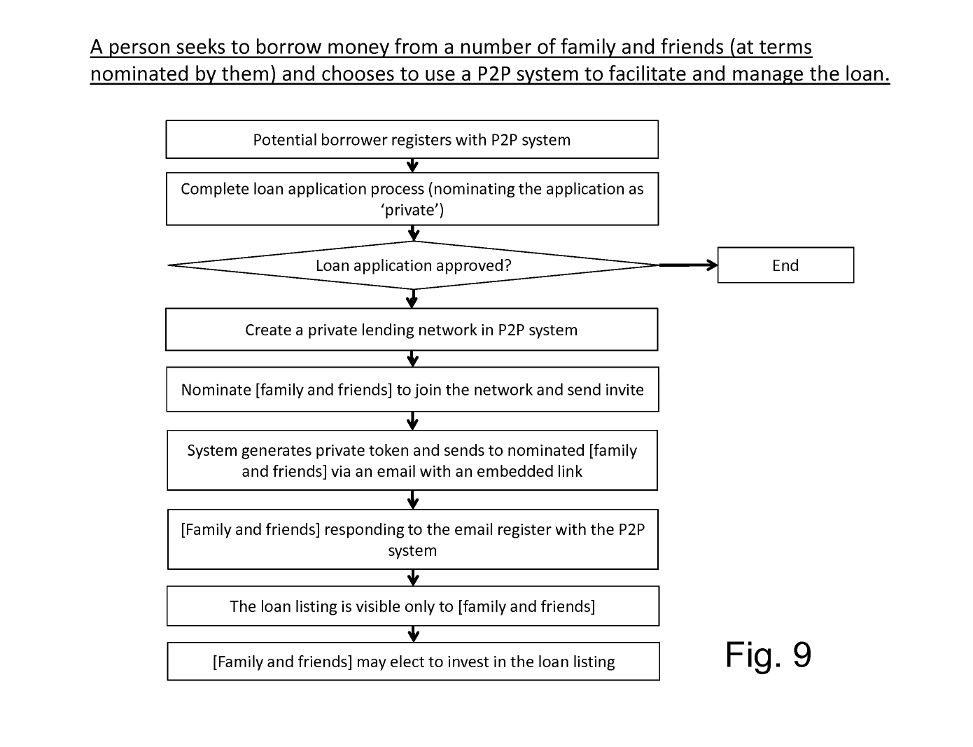

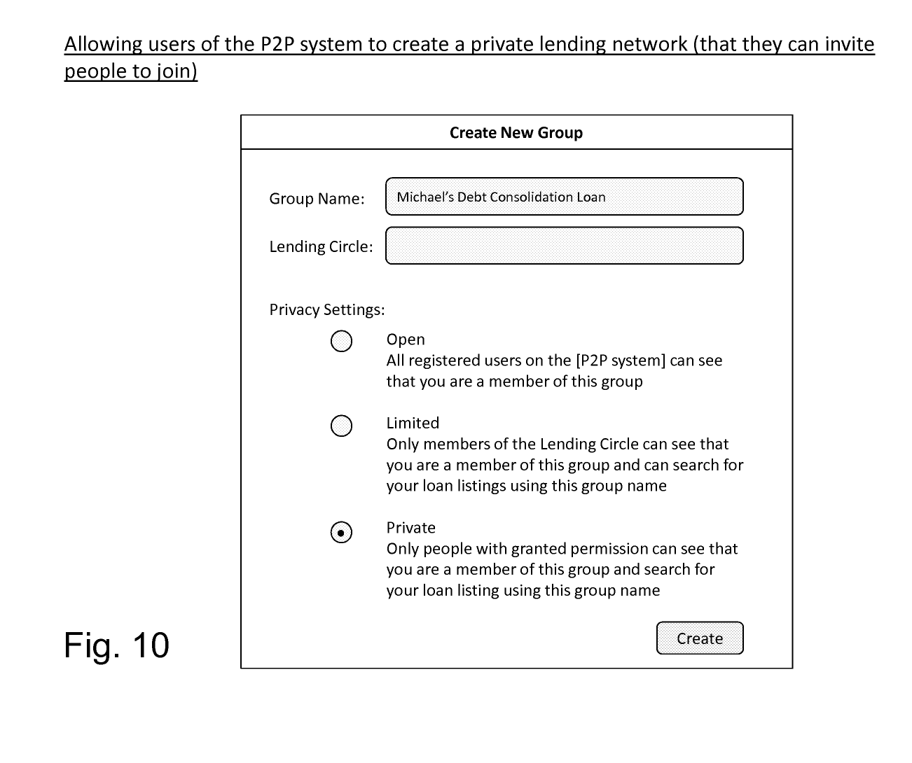

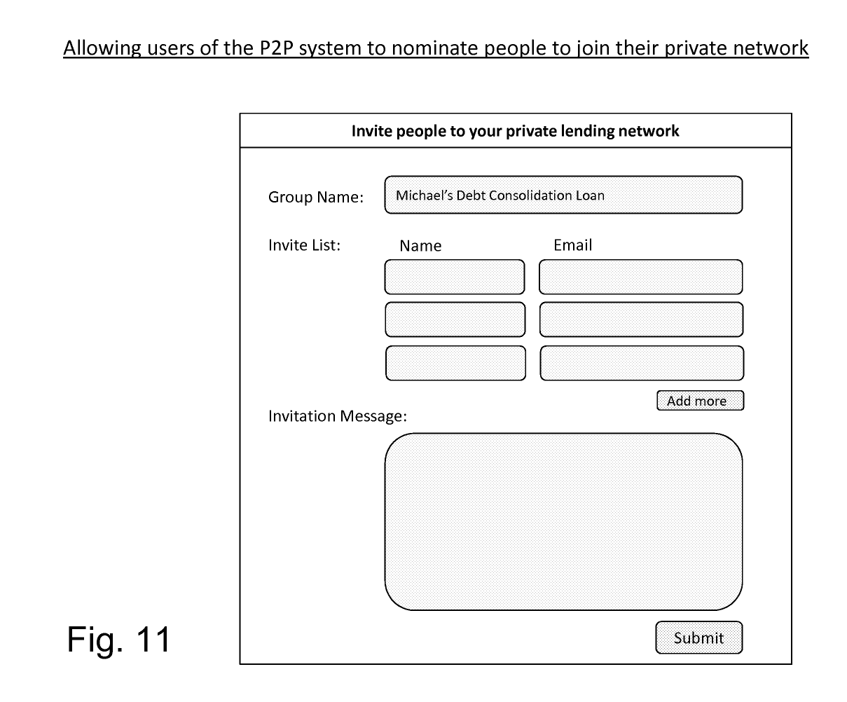

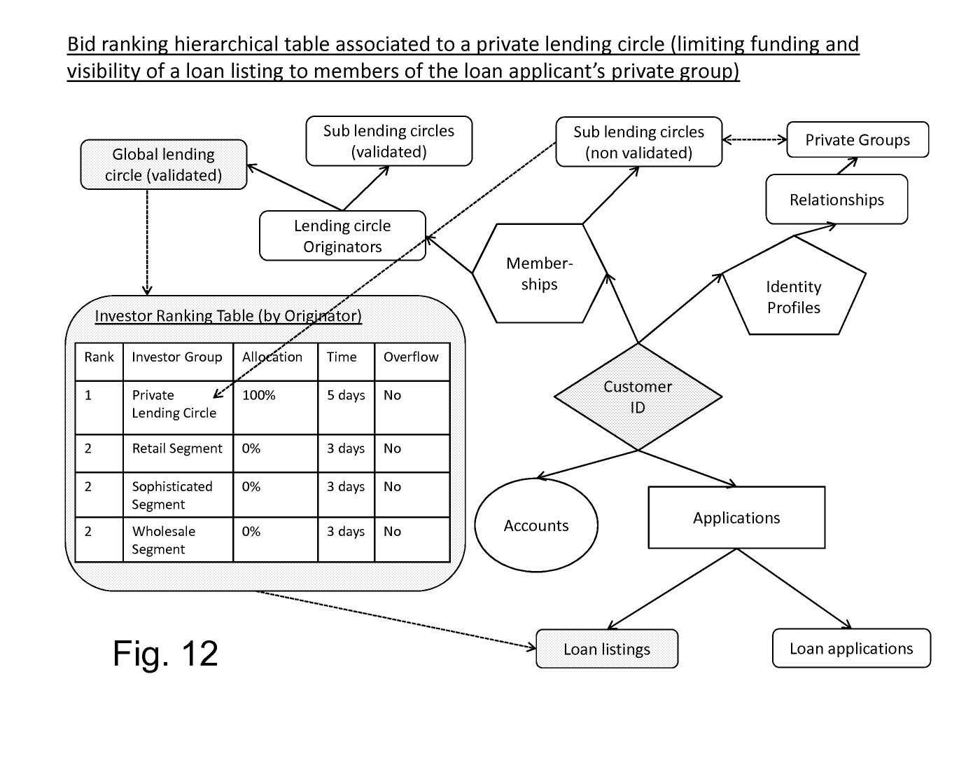

A person seeks to borrow money from a community of a number of family and friends (at terms nominated by them) and chooses to use a P2P system to facilitate and manage the loans. In connection with this scenario, FIG. 9 illustrates and a process-flow describing how a registered user of the system would, for example, establish a private lending circle. Also in connection with this scenario, FIGS. 10-11 illustrate representative graphical user interfaces with input elements that would allow a registered user to create their own private network (via ‘Create New Group’) and then invite people to join. In further connection with this scenario, FIG. 12 depicts how, for instance, the loan applicant's customer ID would be updated to include relationships to members of their private network, and how the Investor Ranking table would provide these members exclusive rights to view and invest in the loan listing. For instance, this scenario could be used in a lending circle between members who have pre-existing relationships (e.g., family and friends, business partners) who seek to utilize the P2P platform as a means of managing direct lending relationships. As an example, a coffee shop that was seeking funding to purchase a new coffee machine could offer their customers the option to invest in the loan. In doing so, the coffee shop would create a lending circle made up of their customers. The customers of the business are in a position to make a partial assessment of the business—such as whether or not the business is busy, growing, provides a high level of product and service etc. As such, the opportunity to invest in the loan to purchase a coffee may provide customers with a unique fixed income investment opportunity. The coffee shop benefits from building loyalty amongst its customer base. The coffee shop would offer its customers the option to join their lending circle via a marketing program that issues a token to customers (via a QR code, email offer, etc.). In turn, interested customers would register with the P2P system as per FIG. 3 and use the token to be connected to the lending circle, which in turn would provide them with priority rights to fund the loan based on the Investor Ranking Table (FIG. 12)

The loan applicant may be responsible for:
Setting loan terms
Nominating other people to be invited to join their lending circle
   Scenario 5: Partially Closed Loop Lending Circles, without an Originator

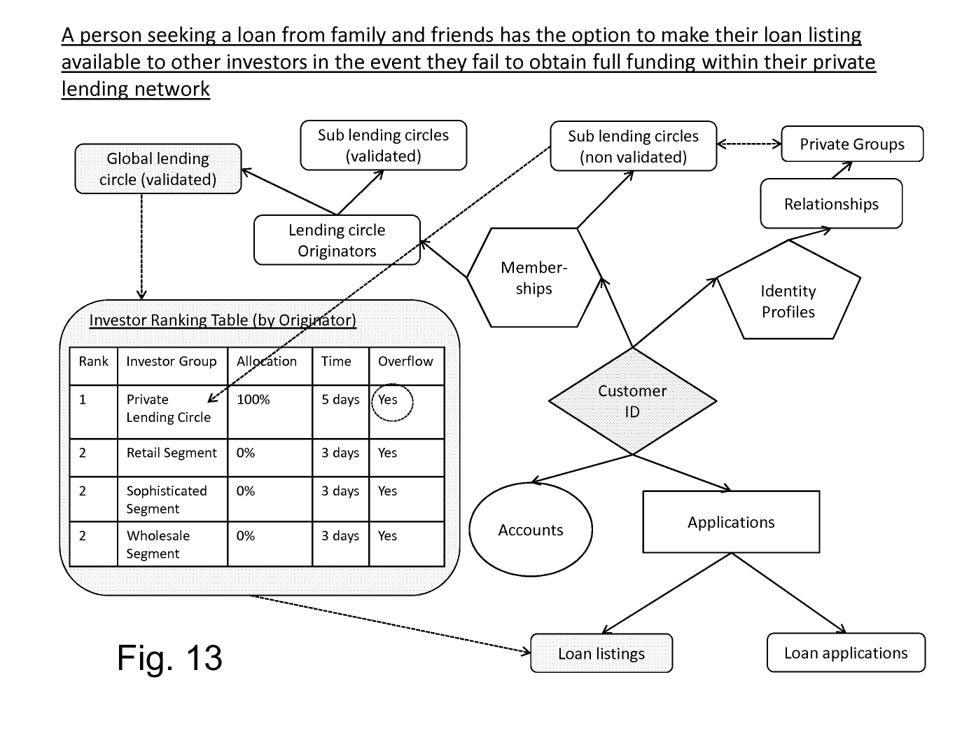

Under this scenario, suppose the same person in Scenario 4 above is unable to obtain as much funding as they hoped through family and friends and chooses to seek the remaining funds from other investors on the P2P system. In connection with this scenario, FIG. 13 shows an example Investor Ranking table updated to allow the loan listing above to be made visible to other investors on the P2P system in the event it is not funded by members of the private lending network. Example: A lending circle as per scenario 4, but with a percentage of investment funds coming from investors outside the lending circle (e.g., 50% of funding for a loan comes from investors who have a relationship with an applicant, while the remaining 50% of funding is made available general investors registered on the P2P platform).

The loan applicant is responsible for:
As per Scenario 4, plus choosing to allow their listing to be made visible to other investors in the event the nominated invested fail to fully fund it.
   Scenario 6: Partially Closed Loops, where the Borrower is Also a Subordinated Investor

A lending circle for loans which have interest and principle repayments at the end of the loan term, where the borrower is also an investor in the loan and takes a subordinated position (i.e., if at the end of the loan there is a shortfall in the interest and principle repayment it is first absorbed by the lender before impacting other investors). The remaining portion of the loan would be open for investment to general investors registered on the P2P platform.

Example: A farmer borrowing funds to purchase livestock, where the livestock are purchased at a young age, fattened and sold for food a year later. In the event the farmer sells the livestock for less than the amount of principle and interest as per loan agreement they incur a capital-loss up to the value of their investment. This may also take the form of a first-loss provision.

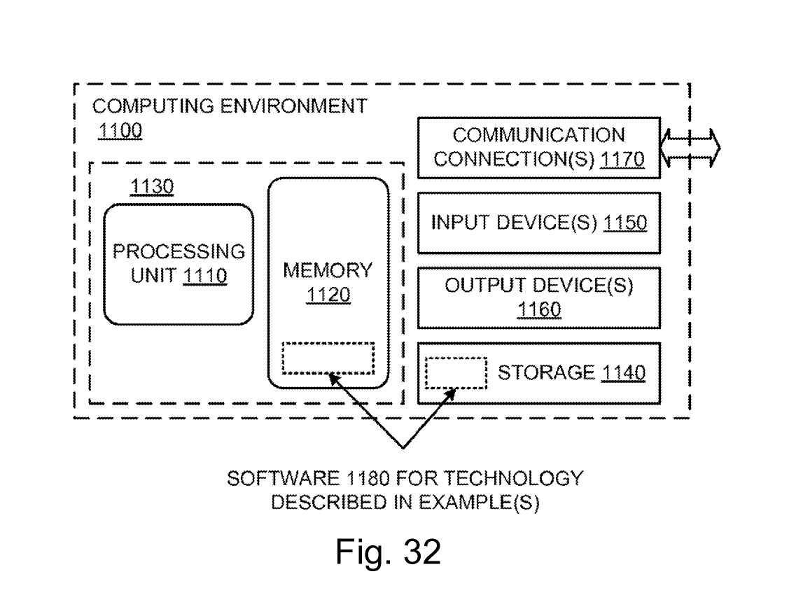

As discussed in more detail below in the section describing FIG. 32, the inventive systems and methods contemplated herein may be implemented on or executed over known general or special purpose computing systems. In general, such computer systems would include one or more processors, and memory for storing executable instructions and data. The systems may also include databases, optical drives, memory card readers, network interface devices for communication with remote systems or devices over a data and telecommunications networks, display screens, physical user interfaces, such as keyboards, mice, touchscreens, touchpads, speakers, printers, and cameras, and a set of stored instructions configured for executing one or more of the inventive concepts disclosed herein. Computers in the system may communicate with each other over the Internet, LANs, WANs, or other known or future data and telecommunications networks. The methods described herein may be stored as executable instructions, e.g., software, on any known or future media for electronic storing data of data, including hard drives, solid state memory modules, removable memory cards, and optical discs. The instructions may include instructions for executing any of the steps contemplated herein, including algorithms and other logical processes; and instructions for generating graphical user interfaces for inputting data or presenting the data and information generated in accordance with the steps described herein.

In certain embodiments of the inventive subject matter, the system allows borrowers to register with a system, apply for lending (new or additional) and obtain funds.

Accordingly the inventive subject matter is a technology and process to automate and generate a loan application and to process the application. For example, in a computer system consisting of a central server in networked communication with one or more other computer systems.

All the foregoing services may be managed and handled via an intermediary party operating a central computer system in networked communication with one or more investor computer systems, and the intermediary party may provide graphical user interfaces for interacting with the investors and presenting information related to potential borrowers, lending offers, loan transactions, and changes in borrower approvability or creditworthiness factors, and changes in loan terms.

FIGS. 1-31 are further representative examples illustrating principles of the inventive subject matter and various embodiments of the inventive subject matter, which may be combined in any number of respects with the scenarios and embodiments disclosed elsewhere herein.

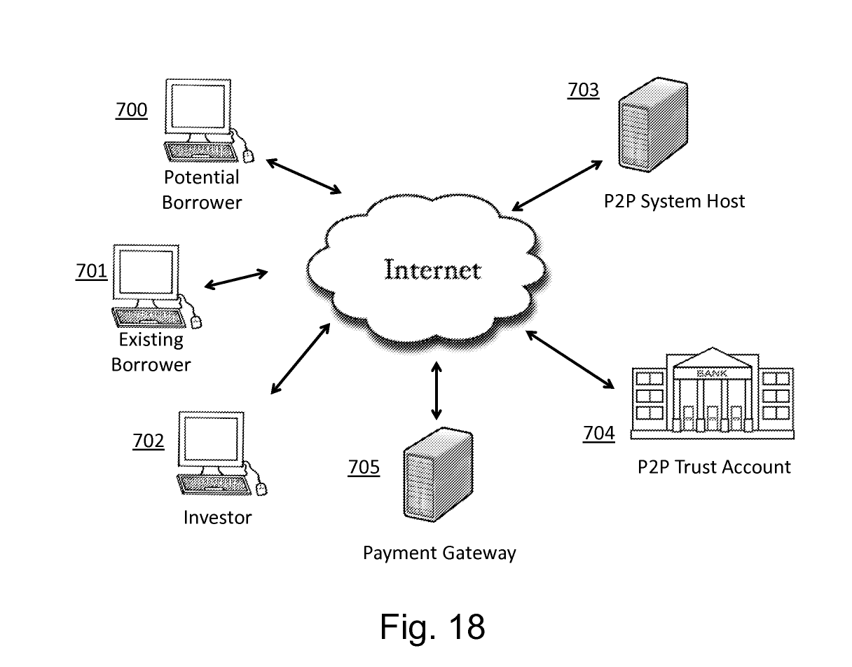

FIG. 18: An Exemplary Peer-to-Peer (P2P) Lending System

Some possible features of a peer-to-peer lending system include one or more of the following, alone or in various combinations.
Potential Borrowers [700], existing Borrowers [701] and Investors [702] can interact with the peer-to-peer lending system via a P2P system host [703] and an Internet connection.
The system enables potential Borrowers to create and submit loan applications that can be viewed by investors and other lenders, who in turn may choose to fund the loans in return for agreed repayment terms (i.e., the borrowers and investors agree on at least interest rates and loan period).
Existing Borrowers may be enabled to see details of their loan accounts on the system and seek new lending via their computer systems and associated graphical user interfaces stored locally or downloadable from the system host [703] computer system, which may also store other software components that are downloadable to systems [701] or [702] of Borrowers or Lenders and provide instructions for performing steps according to the inventive subject matter disclosed herein, including the enabling of online interaction between the parties. System host [703] may also have stored software that enables it to interact with and serve as an application service provider to Borrowers and Lenders with respect to steps according to the inventive subject matter disclosed herein.
Some possible basic aspects of the system with respect to enabling lending among Borrowers and Investors, include one or more of the following, alone or in various combinations:
   (1) Automated creation of the Borrower's loan application by retrieval of data from disparate systems (rather than the Borrower inputting information into a form).
   (2) Assessments of the creditworthiness of the Borrower to enable Investors to make informed decisions about the default risks of the Borrowers and likely investment returns.
   (3) Risk assessments of the creditworthiness of Borrowers makes use of a wide set of traditional data sources, such as credit bureau scores, current bank statements and assets values, and of new data sources, such as banking integration sites (such as Yodlee) that provide direct read only access to bank account and social networking sites (such as Facebook, LinkedIn, Twitter, etc.). Consequently different analysis approaches such as analysis of behavioral patterns across a number of competency areas (such as financial management, advocacy, networking, etc.) may be used to derive, relative to traditional credit scoring, a more accurate assessment of the Borrower, particularly among particular market segments.
   (4) Investors may create and use custom scorecards to apply their own risk assessment criteria in evaluating potential Borrowers. This allows for greater diversity of personal risk/reward trade-offs within the marketplace.
   (5) The system may provide relevant information to both Borrowers and Investors to facilitate efficient operation of the marketplace in terms of the pricing of loans and the duration of time from a loan application being made to being funded.
   (6) The system may also facilitate Investors to (proactively) identify potential and existing Borrowers who meet their investment criteria, and hence further facilitates the provision of credit to credit worthy Borrowers.
Many investors may fund each loan, so a single investor has a fractional interest in any given loan. The system may manage all aspects of the loan being broken into many parts and distributed across many investors, such as collation of investor funds into the initial loan payment, distribution of Borrower repayments back across many Investors, communication to all Investors about the status of the loan, etc.
Investor funds may be held in a Trust account associated with the P2P provider [704].
Once a loan application has been funded by investors, a loan account may be created and funds may be transferred via a payment gateway [705] from the investor accounts within the Trust Account to the borrower's nominated bank account.
Loan repayments made by borrowers may be split into the fractional interests and credited to the Investor's accounts within the Trust Account.

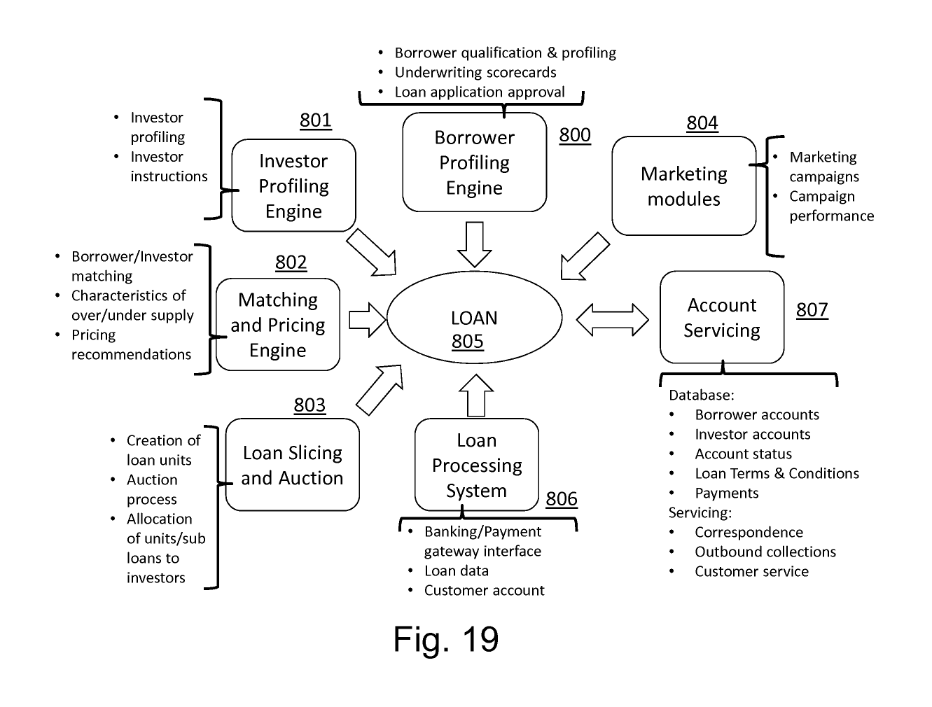

FIG. 19: Components Associated with a Peer-to-Peer (P2P) Lending Site

Some possible components of a peer-to-peer lending site include one or more of the following, alone or in various combinations.
The borrower profiling engine [800] contains a credit underwriting engine that may provide information required to assess the creditworthiness of a potential or existing borrower.
The underwriting engine may extract customer data from disparate systems, including: credit bureau (Veda), Anti Money Laundering (AML), the borrower's bank accounts, social network sites (e.g., LinkedIn, Facebook, Twitter) and the borrower's existing accounts within the P2P lending site.
The Borrower's data retrieved from the various systems may be processed to create a credit profile for each Borrower.
The underwriting engine also contains the credit risk models that are applied to the Borrower's credit profile data to create credit risk scores used to assess the creditworthiness of the Borrower.
Information about Investors and their profiles with respect to the profiles of Borrowers and loan they are seeking to fund are stores in the Investor Profiling engine [801].
The process at [802] may continually monitor and match the Borrower demand for loans against Investor supply of funding, and in doing so provide information back to both Borrowers and Investors that facilitates optimal efficiencies within the marketplace (i.e., Borrowers are able to post loan applications at rates which are funded in reasonable time periods, and Investors are able to efficiently identify loan applications that that meet their investment criteria).
The process at [803] manages the process of splitting loans into units for the purpose of an auction process and allocation to lenders in a way that optimizes the efficiency of the marketplace
Characteristics of marketplace credit over and under supply (for example, an under supply of a particular class of borrower) are sent to marketing modules at [804] that execute campaigns targeting acquisition or upsell of specific borrower or lender profiles in order to balance marketplace credit supply and demand
These components may combine in various ways to facilitate the efficient loan market place [805] between Borrowers and Investors.
The processes associated with [807] and [807] are typical processes associated with the provisioning of new loans and ongoing operations.

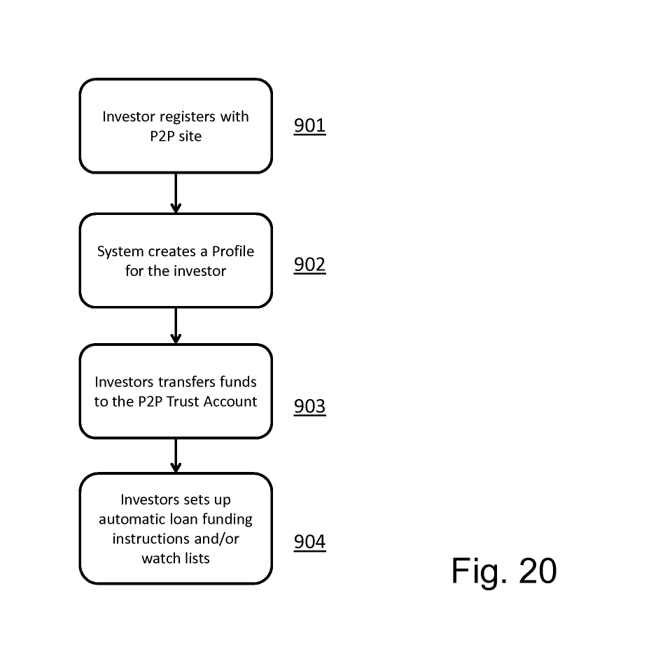

FIG. 20: a Method for an Investor to Register with the System

Some possible features of a method for an Investor to register with system host [703] include one or more of the following, alone or in various combinations.
Before an Investor can fund loans they need to register with the system [901]. As part of the registration process the system may perform security checks, such as Anti Money Laundering (AML).
The system may create an profile for the investor [902] based on information provided in the registration process [901], as well as subsequent information appended to the profile based on information updated by the investor and information derived through investment behavior
The system may create an account for the Investor within the Trust fund [903], which they transfer money into to enable them to fund Borrowers.
At the time of registering, the Investor may be enabled to create a profile of the Borrowers they are interesting in investing in, as well as set up ‘buy’ and ‘watch’ instructions to identify and fund loans that meet their investment criteria [904].

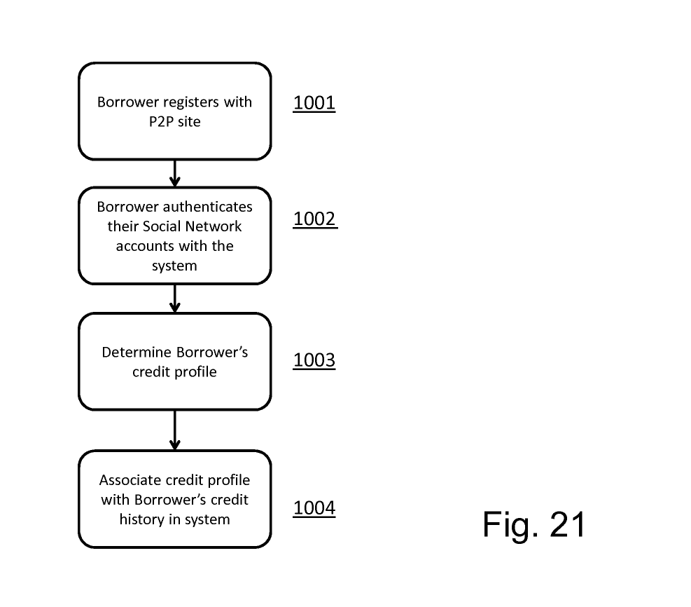

FIG. 21: a Method for a Borrower to Register with the System

Some possible features of a method for a Borrower to register with system host [703] include one or more of the following, alone or in various combinations.
Before a Borrower can seek a loan from Investors the Borrower must first register with the system.
The registration process allows the Borrower to make themselves known to the system, and, in doing so, to be established with a credit profile that will enable them to seek lending.
The initial registration [1001] may require the Borrower to create a user id/password for the system and supply basic information to enable security checks as required by Regulations (AML).
Once registered, the Borrower may be encouraged to register read only access to their banking accounts (via an account aggregation service, such as Yodlee) and access to their Social Network accounts with the system [1002] [FIG. 11]. This registration process has many benefits for both the Borrower and Investors:
   For the Borrower it allows information about them to be extracted automatically rather than needing to be typed into the system.
   It facilitates a wider set of data to be used in their credit profile. This is particularly applicable for segments of customers such as younger Borrowers who have little or no credit history.
   The use of a wider set of data that is behavioral in nature creates a Borrower credit profile that is more descriptive to potential Investors and facilitates better funding decisions to be made.
   The Borrower's credit profile may be continually updated automatically based both behaviors internal to the system (i.e., repayments of loans) and external (such as overall financial accounts, changes to employment, etc.), enabling the creation of new behavior based pricing models that benefit both the Borrower and the Investor.
The system creates a scorecard, such as a credit profile for the Borrower [1003] by retrieving and compiling information about the Borrower's history relevant to their use of credit.
At [1004] If the Borrower is an existing or past customer of the system [703] their internal data (e.g., repayment of existing loans) may provide significant insight and may be associated with the external data to create of an integrated credit profile for the Borrower

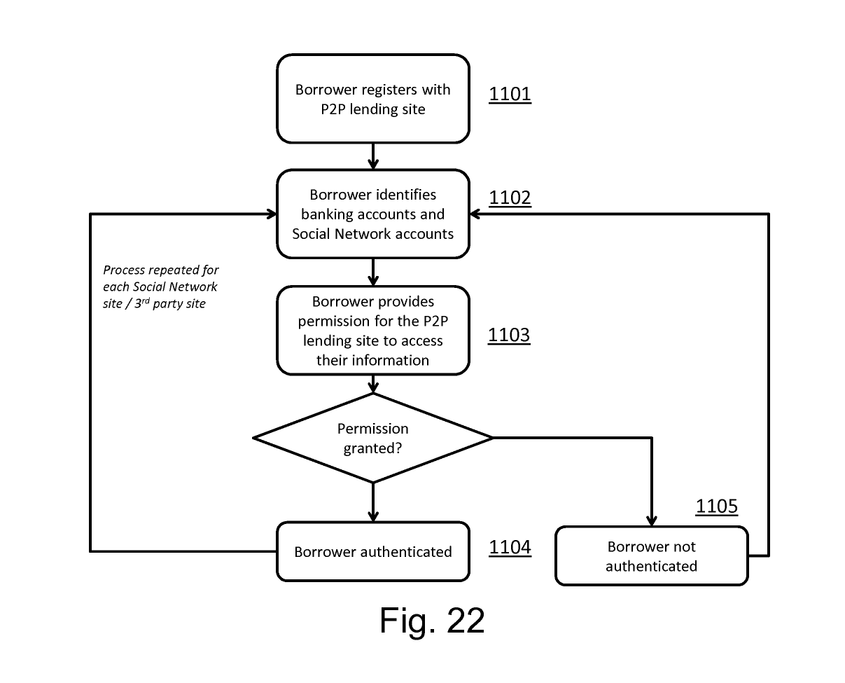

FIG. 22: The Borrower Associates their Scorecard Related Data Sources, e.g., Banking and Social Network Accounts, with the System

Some possible features of a method for a Borrower to associate their third-party scorecard-related data sources with system host [703] include one or more of the following, alone or in various combinations.
On registering with the site [1101] the Borrower may be offered a list of banking aggregation and Social Network sites to associate with their account [1102].
In doing so the Borrower goes through a standard process with each site (e.g., via a pop up window) whereby they login to the site and provides permission [1103] for the P2P lending site to access their information via an API [1104].

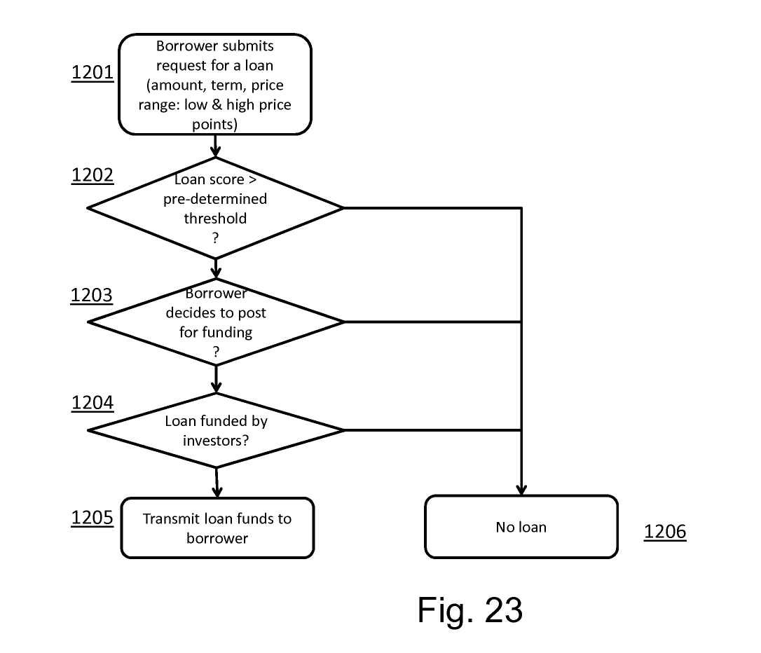

FIG. 23: a Borrower Requests a Loan

Some possible features of a method for a Borrower to request a loan via a system host [703] include one or more of the following, alone or in various combinations.
The lending process may begin with a registered Borrower (potential or existing) submitting a loan request on the system [1201]. The information required at this point is the amount of lending they are seeking, the term of the loan (e.g., 1, 2, or 3 years), and an indication of the interest rate they are seeking, which may be expressed as low and high points of a range.
The system determines a credit score, e.g., creditworthiness, of the Borrower with specific respect to their loan application via the calculation of a loan score [1202]. The Borrower's loan application is deemed to be creditworthy if the loan score is above a threshold, and they are then given the option to post it on the system [1203] where it can be viewed and funded by one or more Investors.
One purpose of approving the loan application for funding [1202] is to enable some form of regulation of the loans marketplace, particularly in terms of the general quality of loan applications on the system.
At step [1203], a Borrower may decide to post their loan application. The Borrower may be provided with information about the likely time to obtain funding for price points within their range. This information enables the borrower to make an informed decision about the best interest rate at which to set their loan application relative to their desired timing for funding, for example.
At step [1204], Investors can assess details of the Borrower's loan application (including, for example, relevant, de-identified details from the Borrower's credit profile) and decide whether or not to fund the loan. In certain embodiments, the inventive subject matter contemplates that multiple Investors must collectively fund a given loan. In such a system, since any given Investor is able to fund only a fraction of the loan, many Investors must choose to fund a loan before the Borrower's desired loan amount is obtained.
At step [1205], once a sufficient number of Investors commit to funding a Borrower's loan application so that the requested loan amount is achieved, the system [703] may create a loan account for the Borrower on the system, debit funds from the Trust accounts of Investors, and transmit the funds to the Borrower's nominated bank account.

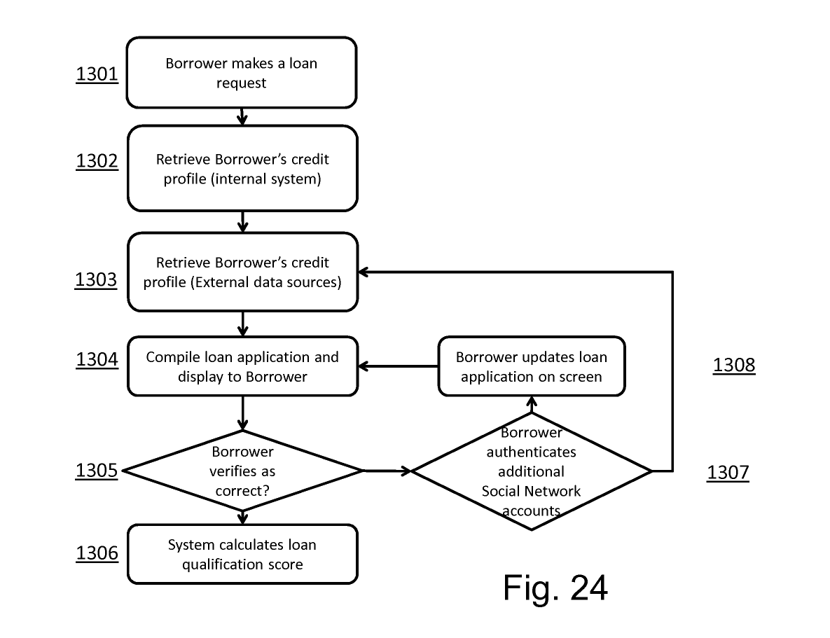

FIG. 24: a Loan Score is Created for a Borrower

Some possible features of a method for a loan score to be created for a Borrower include one or more of the following, alone or in various combinations.
It is common practice for companies offering lending to potential Borrowers to use credit bureaus, personal details (e.g., employment status, job title, living situation, etc.), and the current financial statements in deciding to approve a loan.
In certain embodiments of the inventive process, the system enables Investors to make funding decisions based on the traditional information above, and additional information not (typically) used elsewhere. This may include use of longitudinal financial data (i.e., rather than a snapshot) and social network data that is then analyzed to identify behavior based competencies exhibited by the Borrower:
   The benefit of using longitudinal financial data is that it provides much greater insight on factors such as the stability of a Borrower's income and expenses over time, and their ability to budget and manage money over a period of time.
   Identification and measurement of behavior-based competencies allow Borrowers to be assessed relative to their peers at similar life-stages and calibrated against later life-stage groups. This solves significant limitations of current approaches that discriminate against loan applicants who have limited credit history (principally due to age, but also significant to immigrants, stay at home partners, etc.).
   Behavioral based competencies are assessed via analysis and scoring of the Borrower's longitudinal financial data and Social Network data under the categories of, for example, Financial Management, Networking, Advocacy, Leadership and Accountability.
   As an example, a person's LinkedIn profile provides insight to their competency in Networking (e.g., the number and profile of their connections), Advocacy (e.g., evidence of recommendations), Leadership (e.g., posting behaviors and responses), etc.
   Further details of the method of calculating the behavioral competency scores are shown in FIG. 20
   For example, consider Borrowers seeking loans aged 21 years, who have identical credit bureau risk scores and incomes. The first applicant is a graduate lawyer working for a major firm, with 100+ LinkedIn connections across both senior and junior level people; while the second applicant works in a retail shop with no LinkedIn profile. The additional information made available is valuable to potential Investors to discriminate between the two applicants, and, in all likelihood, the first applicant would generate more demand than the second, which would translate to more funding offers and potentially a better rate.
Therefore, the Borrower's loan score may be a composite score of at least 3 components: (1) credit bureau score, (2) current financial data and (3) behavioral competency scores. For example, a composite score might be made up of a 50% weighting for the credit bureau score, 20% weighting for the current financial data and 30% weighting for behavioral competency scores. These weightings can be made transparent to both Borrower's and Investors and even customized by Investors wishing to create their own scoring models (discussed elsewhere, FIG. 10).
The process of creating a loan score for a Borrower may begin with the Borrower making a loan request [1301] (with the process as per FIG. 12), and the system retrieving the Borrower's credit file, made up of internal data [1302] (if they are an existing customer of the system) and external data [1303].
The Borrower's credit profile, in conjunction with the specific loan request, form the basis of a loan application that is auto-generated by the system [703] and which may be displayed to the Borrower [1304] via online communication.
The Borrower reviews the loan application data and has the option to update or correct information. For example the system has extracted data from LinkedIn including their job title, which is out of date; so, the Borrower has the option to update the piece of data by either authenticating additional social network accounts [1307], such as LinkedIn, and refreshing the application, or manually updating the data within the application [1308]
If the application data is correct and verified [1305] by the Borrower, they submit their lending application and the system calculates a loan score for that application [1306].

Accordingly in view of the foregoing ways to assess a borrower, as used herein, a “borrower profile” means the collection of data for a given borrower that is sufficient to enable an investor to assess a borrower for loan qualification. The borrower profile typically would include traditional data on the creditworthiness of a borrower. It may also include behavioral competency scores or data on specific memberships of a borrower or the specific purpose of a borrower's loan.

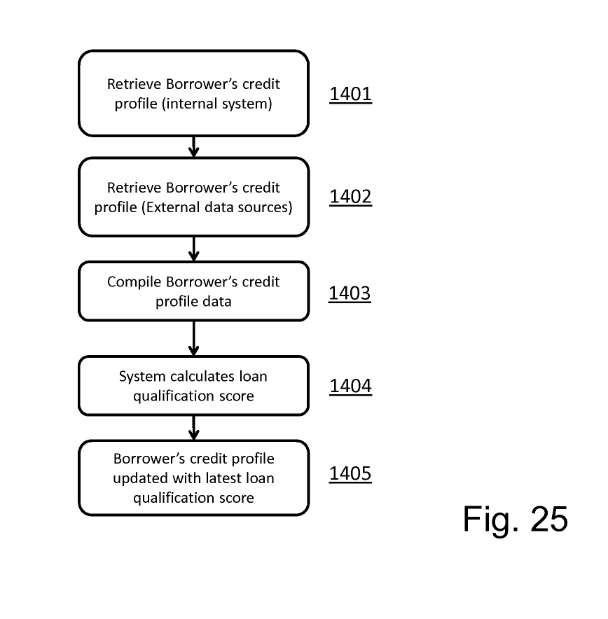

FIG. 25: a Credit Score is Updated for a Borrower

Some possible features of a method related to a credit score update for a Borrower through system host [703] include one or more of the following, alone or in various combinations.
This process enables an existing Borrower's credit profile data [1401, 1402] to be retrieved, compiled [1403] and credit score recalculated [1404] to be updated at any time.
A Borrower's credit score is different from their loan score (i.e., a loan score is effectively the Borrower's credit score for a specific loan)
Over time a Borrower's credit score may improve or decline based on their repayment behavior on their current loans on the system, credit behavior on other products outside the system and more generally by their behaviors as measured by the behavioral competency scores.
The system may regularly recalculate the Borrower's credit score and update their credit profile [1405].
This provides the basis of new dynamic pricing models between Borrowers and Investors.

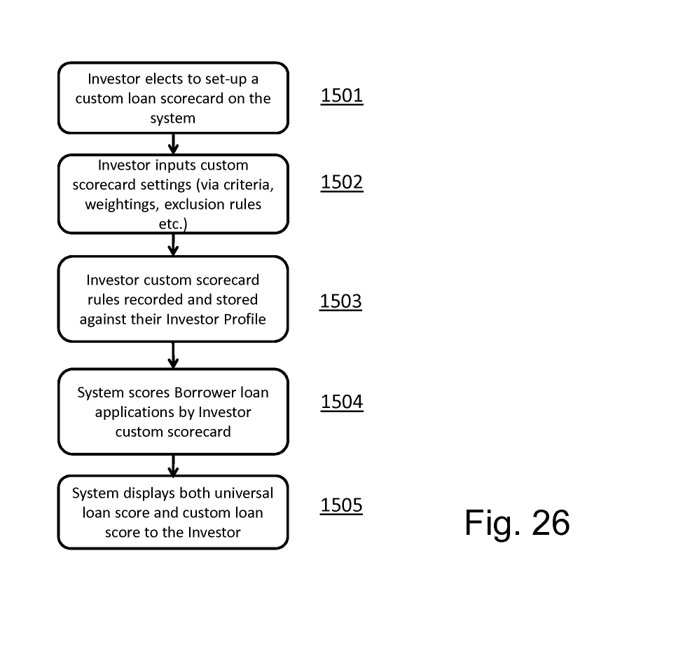

FIG. 26: Enabling Investors to Set Up a Borrower Loan Scorecard to Score Loan Applications

Some possible features of a method for Investors and other lenders to setup a scorecard for loans through system host [703] include one or more of the following, alone or in various combinations.
The scorecard process recognizes that the role of the system [703]/market maker is to facilitate lending among Borrowers and Investors, and that in order to do this most effectively must facilitate Investors to apply their own risk criteria/bias in discriminating among potential Borrowers.
The system may enable this by allowing Investors to create custom loan scorecards to score potential Borrowers.
As a result, the system may facilitate many niche markets to exist that promote provision of credit to a wider set of potential Borrowers. This is particularly true when comparing a P2P lending system to a traditional lending provided by a bank, where there is a single scorecard and single credit policy—which in turn leads to some credit worthy segments of the market being able to obtain limited or no credit as they don't neatly fit the bank's criteria.
The system provides Investors with the option to create a customer scorecard [1501], whereby they are able to set their own weighting to scorecard components, set exclusion rules and adjust criteria.
As an example, an Investor who was concerned about boom/bust economic conditions in areas dominated by the mining industry could set a rule that excluded specific geographic locations. In the same way, an Investor could choose to weight Borrowers who were graduates of particular universities higher. Another Investor might choose to apply a higher weighting to behavioral competencies and less on the bureau score.
The Investor's customer scorecard criteria may be stored in system [703] against their Investor Profile [1503] and used to forecast demand for Borrower credit profiles [606].
In step [1504], an underwriting engine may score Borrower credit profiles by the Investor custom scorecards (in addition the standard system scorecards).
Once an Investor has set up a custom scorecard, the system may display to them both the standard/system credit scores and customer credit score for Borrowers [1505].

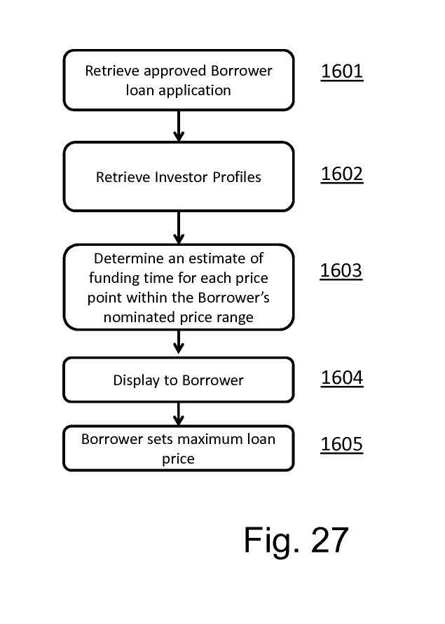

FIG. 27: Facilitating Borrowers to Set Loan Pricing

Some possible features of a method for facilitating a Borrower to set loan pricing through system host [703] include one or more of the following, alone or in various combinations.
The key trade-off for Borrowers is the interest rate they pay for lending versus the time taken for their loan to be funded by Investors.
Similarly Investors are seeking to maximize their rate of return on the loans they fund, while keep their money invested rather than sitting waiting to fund loans.
So, in certain embodiments, the system [703] seeks to enable Borrowers and Investors to trade off interest rates versus time (i.e., funding time) to achieve an optimal market place.
To achieve this, Borrowers may be provided with information about the availability of funding for their application by interest rate. FIG. 3 shows a screenshot of an example offer presented to a borrower at [210], whereby a Borrower can choose to accept an interest rate of 13.5% and receive immediate funding, or they can elect to post their application at lower interest rates with progressively longer funding times (and less certainty of being funded). In this process, the system calculates Investor demand for each Borrower's loan application and the level of interest rate to provide the estimates of funding time by interest rate.
This process starts by retrieval of both approved Borrower loan applications [1601] and Investor profiles [1602] from the system and a matching process to determine an estimate of funding time for each price point within the Borrower's nominated price range [1603].
This information is presented to the Borrower (as per FIG. 3) to enable them to trade-off rate versus funding time in setting their maximum loan pricing (i.e., the maximum interest rate they are prepared to pay for a loan)

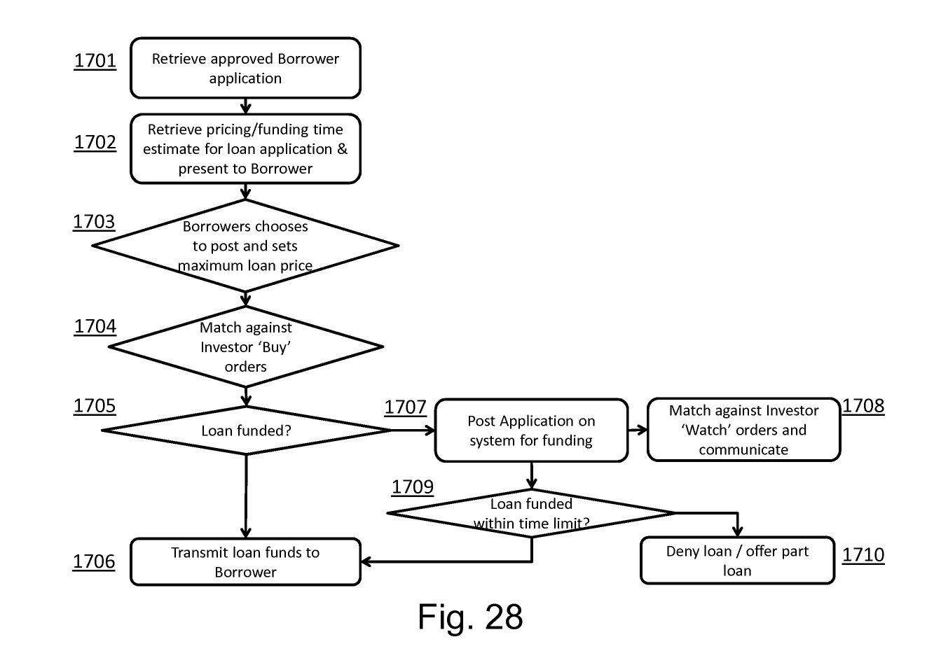

FIG. 28: Posting a Loan Application on the System for Funding

Some possible features of posting a loan application on system [703] for funding include some or all of the steps described in FIG. 28, alone or in various combinations:
Borrowers with approved loan applications choosing to post it on the system for funding set their loan terms and (maximum) interest rate [1701-1703].
The system will first match against existing applicable ‘buy’ bids in the system [1704], and then post [1707] remaining units for funding. Where the loan application meets a ‘watch’ criteria set up by an investor, the investor is notified [1708].
A maximum time limit is set by the market place for the loan to be funded. If the loan is not fully funded by the time the time limit [1709] is reached the borrower may elect to take a lower level of funding, or the loan may be denied.
Once loans are deemed to be funded, a loan account is established by the system and money is collated from the trust accounts of the lenders and transmitted to the borrower [1705-1706]. If a full funding offer is not achieved, the loan is denied or an offer of a partial loan, or loan with different terms than specified by the borrower, may be communicated to the borrower [1710].

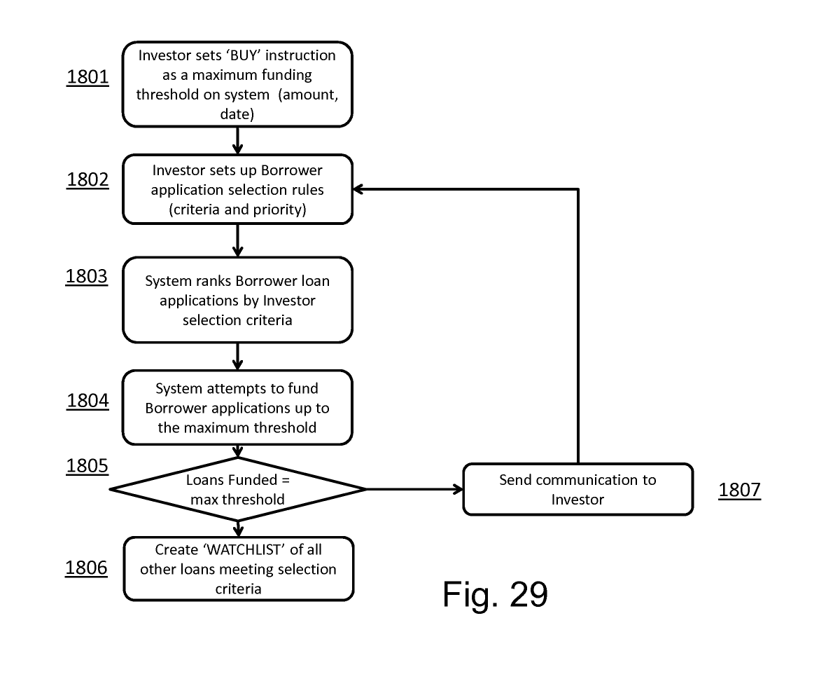

FIG. 29: Enabling Investors to Set Automatic Funding Instructions

According to certain embodiments of the inventive subject matter, some possible features of a method for enabling Investors to set automatic funding instructions through system host [703] include one or more of the following, alone or in various combinations.
In step [1801], Investors have the option to choose Borrower loan applications manually or automatically. In an automatic setting the Investor sets up a ‘Buy’ instruction with a maximum funding threshold for a given period of time (e.g., set to automatically fund up to $1000 of loan application (units) within the next 7 days, where the Investor purchases up to 1% of any qualifying loan application amount).
In step [1802], as part of setting up the ‘buy’ instruction on the system, the Investor sets up an ordered set of criteria to select and rank loan applications for funding (e.g., 1. loan score >670, 2. loan size $5,000-$10,000, 3. interest rate 12.5%-13.0%). The criteria can include the Investors own customer loan score as part of the criteria.
In step [1803], the system then ranks loan applications by the Investors criteria and funds loans [1805] up to the value of the set threshold.
In step [1806], if the value of loan applications meeting the criteria exceeds the funding threshold the remaining (unfunded) loan applications may be placed on a ‘watchlist’ and tracked for possible funding in the future.
Alternatively an Investor can set-up a ‘watchlist’ instead of a ‘buy’ instruction.
In step [1807], if the value of loan applications meeting the criteria falls short of the funding threshold, the Investor is advised so that they have the option to adjust their selection criteria.

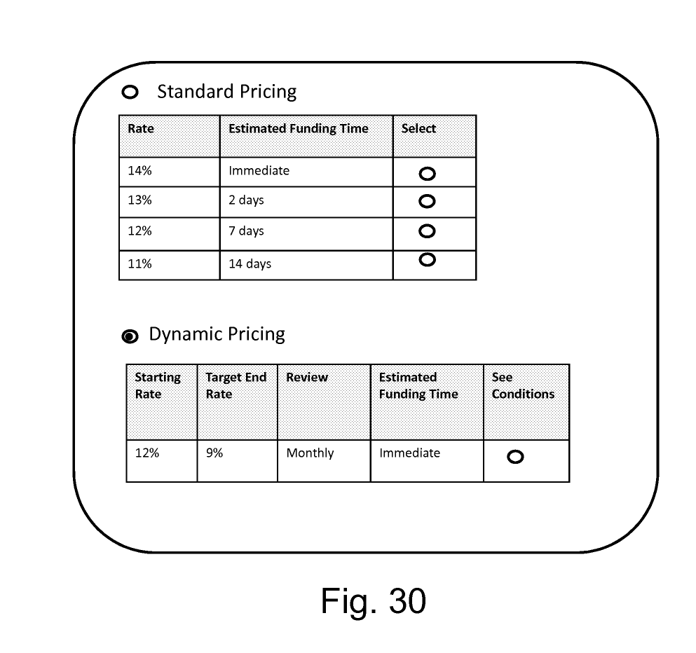

FIG. 30: Setting Up Loans with Dynamic Pricing

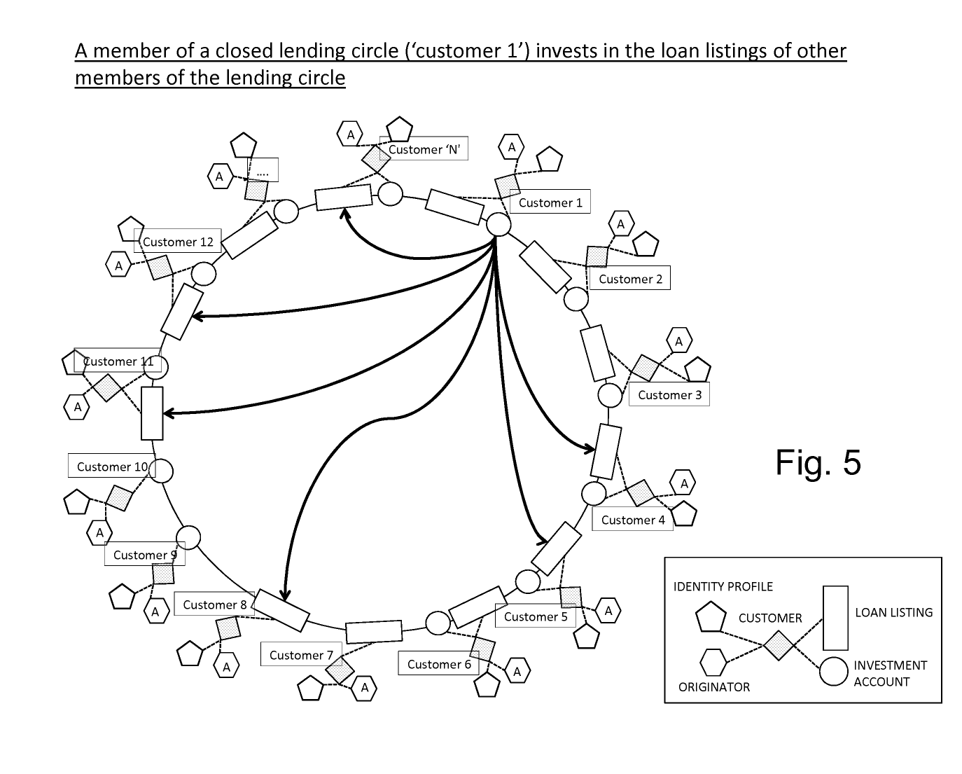

Some possible features of a method for facilitating the setting up of loans with dynamic pricing through system host [703] include one or more of the following, alone or in various combinations.
A key aspect of the role of the P2P lending site is to facilitate a transparent and efficient loans market place.
The process of assessing creditworthiness represents an approximation of default so that lending can be priced to accurately reflect the future returns to an Investor net of losses.
An alternative approach is the creation of pricing mechanisms that serve in the interests of both Investors and Borrowers.
This is achieved in this system by allowing Borrowers to request dynamic pricing whereby their interest rate is continually or at predetermined times or events adjusted in-line with their credit score (calculated as per FIG. 25, for example).
In FIG. 30, the Borrower is given the option to choose between standard pricing or dynamic pricing, when they choose to post their loan application for funding.
A dynamic pricing offer has a starting rate of interest and a target end rate of interest. These interest rate figures may be determined by the system based on the current credit score of the Borrower and a forecast future credit score at the end of the loan. The calculation of the forecast future credit score may include the use of the Borrower's behavior based competency scores and benchmarking of credit score movements by like profiles.
A dynamic pricing offer may include a set of terms and conditions (as per FIG. 5) that provides a guide of credit score movements for a range of repayment behaviors.
In practice, the Borrower is able to achieve the target end interest rate by ensuring their repayment behavior is within the conditions outlined.
Conversely, if the Borrower's credit score deteriorates their interest rate may increase under this model for dynamic pricing.

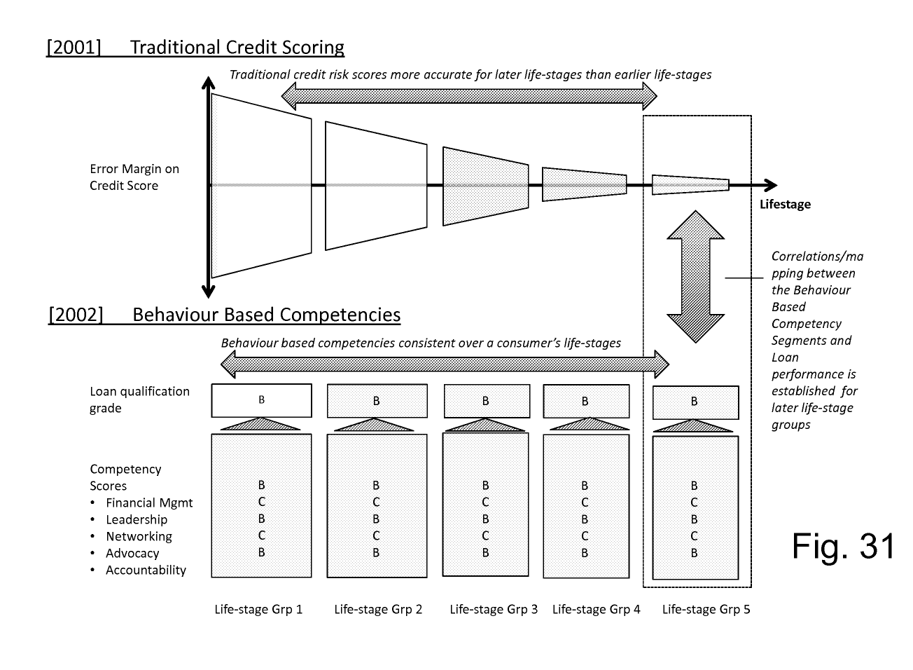

FIG. 31: Description of the Development of Behavior Based Competency Scores

Some possible features of a method for facilitating development of behavior based competency scores through system host [703] include one or more of the following, alone or in various combinations.
Behavioral data is extracted by system [703] from third party sources for a large sample of people.
Data across the different data sources is collated for predetermined individuals and prepared for scoring.
Each person is scored based on their behaviors across a plurality of categories such as some or all of the following five categories: Financial Management, Leadership, Networking, Advocacy, and Accountability.
People are grouped by their life-stage, and scores are calibrated within each group to identify appropriate cut-off scores that distribute customers according to their level for each competency (i.e., enabling people to be scored as having a ‘superior’ level of competency through to ‘inferior’ level of competency relative to their life-stage peers).
Behavior Based Competency Scores are correlated to Credit Risk Scores:
   For example, several groups are defined, such as a late-life-stage group (e.g., 45-55 years). Each group is isolated. The behavior based competency scores of each person is correlated against their credit risk performance, and a model/algorithm is developed that allows a credit risk score to be calculated using only the behavioral based competency scores.
Allocation into Behavioral Segments
   The algorithm may then be used to score all people across all life-stage groups.
   Each person may be allocated to a behavioral segment based on their score.

### Computing Environments

FIG. 32 illustrates a generalized example of a suitable computing environment 1100 in which described methods, embodiments, techniques, and technologies may be implemented. The computing environment 1100 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices. With reference to FIG. 32, the computing environment 1100 includes at least one central processing unit 1110 and memory 1120. In FIG. 8, this most basic configuration 1130 is included within a dashed line. The central processing unit 1110 executes computer-executable instructions and may be a real or a virtual processor. In a multi-processing system, multiple processing units execute computer-executable instructions to increase processing power and as such, multiple processors can be running simultaneously. The memory 1120 may be volatile memory (e.g., registers, cache, RAM), non-volatile memory (e.g., ROM, EEPROM, flash memory, etc.), or some combination of the two. The memory 1120 stores software or other instructions 1180 that can, for example, implement one or more of the innovative technologies described herein. A computing environment may have additional features. For example, the computing environment 1100 includes storage 1140, one or more input devices 1150, one or more output devices 1160, and one or more communication connections 1170. An interconnection mechanism (not shown) such as a bus, a controller, or a network, interconnects the components of the computing environment 1100. Typically, operating system software (not shown) provides an operating environment for other software executing in the computing environment 1100, and coordinates activities of the components of the computing environment 1100. The storage 1140 may be removable or non-removable, and includes magnetic disks, magnetic tapes or cassettes, CD-ROMs, CD-RWs, DVDs, or any other medium which can be used to store information and which can be accessed within the computing environment 1100. The storage 1140 stores instructions for the software or other instructions 1180, which can implement technologies described herein. The input device(s) 1150 may be a touch input device, such as a keyboard, keypad, mouse, pen, or trackball, a voice input device, a scanning device, or another device, that provides input to the computing environment 1100. For audio, the input device(s) 1150 may be a sound card or similar device that accepts audio input in analog or digital form, or a CD-ROM reader that provides audio samples to the computing environment 1100. The output device(s) 1160 may be a display, printer, speaker, DVD or CD writer, or another device that provides output from the computing environment 1100.

The communication connection(s) 1170 enable communication over a communication medium (e.g., a connecting network) to another computing entity. The communication medium conveys information such as computer-executable instructions, compressed graphics information, or other data. The information can pertain to a physical parameter observed by a sensor or pertaining to a command issued by a controller, e.g., to invoke a change in an operation of a component in the system 10 (FIG. 1).

Computer-readable media are any available media that can be accessed within a computing environment 1100. By way of example, and not limitation, with the computing environment 1100, computer-readable media include memory 1120, storage 1140, communication media (not shown), and combinations of any of the above.

### Other Exemplary Embodiments

The examples described herein generally concern improved CRM. Other embodiments than those described above in detail are contemplated based on the principles disclosed herein, together with any attendant changes in configurations of the respective apparatus and changes in logic flow described herein. Incorporating the principles disclosed herein, it is possible to provide a wide variety of improved CRM systems.

Directions and references (e.g., up, down, top, bottom, left, right, rearward, forward, etc.) may be used to facilitate discussion of the drawings but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by references in its entirety for all purposes.

The principles described above in connection with any particular example can be combined with the principles described in connection with any one or more of the other examples. Accordingly, this detailed description shall not be construed in a limiting sense, and following a review of this disclosure, those of ordinary skill in the art will appreciate the wide variety of CRM and other systems that can be devised using the various concepts described herein. Moreover, those of ordinary skill in the art will appreciate that the exemplary embodiments disclosed herein can be adapted to various configurations without departing from the disclosed principles.

The previous description of the disclosed embodiments is provided to enable any person skilled in the art to make or use the disclosed innovations. Various modifications to those embodiments will be readily apparent to those skilled in the art, and the generic principles defined herein may be applied to other embodiments without departing from the spirit or scope of this disclosure. Thus, the claimed inventions are not intended to be limited to the embodiments shown herein, but are to be accorded the full scope consistent with the language of the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed as means plus function claim unless the element is expressly recited using the phrase “means for” or “step for”.

1. A computer implemented method for managing the identity of participants within a P2P lending system hosted on a computer network, comprising:
storing a plurality of records of borrower profiles in a database on the system, each profile being for a different borrower, each borrower being a member of an organized community of members;
storing one or more records of lending circles representing an organized community of members;
in the system, associating a borrower profile record with a loan offering record stored on the system and with a lending circle record; and
allocating or disseminating a borrower profile and associated loan offering record to one or more investors, the borrower profile including sufficient profile information about a borrower to enable investors to make funding decisions for the loan offering, the borrower profile excluding data directly identifying the borrower.

2. The method of claim 1 wherein the organized community of members comprises the loan originator.

3. The method of claim 1 wherein the system stores a plurality of records of different lending circles.

4. The method of claim 1 wherein the organized community of members comprises a community for a professional practice.

5. The method of claim 2 wherein the borrower profile is provided to a plurality of investors who are members of the same organized community of members as the borrower.

6. The method of claim 1 wherein the borrower profile comprises behavioral competency data and traditional creditworthiness data.

7. The method of claim 1 further comprising receiving from an investor and storing on the system a decision for funding a loan offering.

8. The method of claim 7 wherein the system provides to a borrower a decision on the funding of the loan offering.

9. The method of claim 8 wherein the identity of an investor or investors making a decision is not provided to the borrower.

10. A computer system, comprising stored instructions for:
storing a plurality of records of borrower profiles in a database on the system, each profile being for a different borrower, each borrower being a member of an organized community of members;
storing one or more records of lending circles representing an organized community of members;
in the system, allocating or disseminating a borrower profile with a loan offering record stored on the system and with a lending circle record; and
providing a borrower profile and associated loan offering record to one or more investors, the borrower profile including sufficient profile information about a borrower to enable investors to make funding decisions for the loan offering, the borrower profile excluding data directly identifying the borrower.

11. The computer system of claim 10 further comprising a borrower profiling engine for generating the borrower profile.

12. The computer system of claim 10 further comprising a matching and pricing engine for matching one or more borrowers with one or more investors.

13. A computer implemented method for creating a lending circle within a P2P lending system hosted on a computer network, comprising:
providing a graphical user interface to receiving an organized community of members;
receiving via the graphical user interface a profile for a defined circle of lending and storing the profile as a record in a database; and
in the system, allocating or disseminating one or more borrower profile records stored on the system with a lending circle record; and
creating a unique token for the borrower profile records, the token not representing a personal identification of a given borrower.

14. The method of claim 1 wherein the allocating or disseminating is within a closed lending circle.

15. The system of claim 10 wherein the allocating or disseminating is within a closed lending circle.

16. The system of claim 10 wherein the allocating or disseminating is within a closed lending circle.

17. The method of claim 1 wherein the method includes providing a graphical user interface to a borrower, and receiving from the borrower an input for selecting whether the borrower's borrower profile is allocated or disseminated to a closed or open lending circle.

18. The system of claim 10 wherein the system is configured to store or generate a graphical user interface for a borrower to interactively select whether the borrower's borrower profile is allocated or disseminated to a closed or open lending circle.

19. The system of claim 12 wherein the matching and pricing engine allocates or disseminates the borrower profile to a plurality of investors within a lending circle and receives a plurality of funding offers from a plurality of the investors.

20. The method of claim 1 wherein a matching and pricing engine allocates or disseminates the borrower profile to a plurality of investors within a lending circle and the matching and pricing engine receiving a plurality of funding offers from a plurality of the investors.

21. The method of claim 20 wherein the matching and pricing engine receives a plurality of funding offers from a plurality of the investors.
